(19) United States
(12) Patent Application Publication
(10) Pub. No.: US 2018/0197393 A1
(43) Pub. Date: Jul. 12, 2018

(54) METHOD AND SYSTEM FOR REPRESENTING SENSOR ASSOCIATED DATA

(71) Applicants: Allied Telesis Holdings Kabushiki Kaisha, Tokyo (JP); ALLIED TELESIS, INC., Bothell, WA (US)

(72) Inventors: Joseph L. Gallo, Santa Cruz, CA (US); Ferdinand E. K. de Antoni, Manila (PH); Scott Gill, Taguig (PH); Daniel Stellick, Geneva, IL (US)

(21) Appl. No.: 14/315,286

(22) Filed: Jun. 25, 2014

Related U.S. Application Data
(63) Continuation-in-part of application No. 14/315,289, filed on Jun. 25, 2014, now abandoned.
Application No. 14/315,289 is a continuation-in-part of application No. 14/315,317, filed on Jun. 25, 2014, now abandoned.
Application No. 14/315,317 is a continuation-in-part of application No. 14/315,320, filed on Jun. 25, 2014, now abandoned.
Application No. 14/315,320 is a continuation-in-part of application No. 14/315,322, filed on Jun. 25, 2014, now abandoned.

(51) Int. Cl. G08B 21/12; G08B 21/18; G06F 3/0484

(52) U.S. Cl. CPC G08B 21/12; G06F 3/04847; G08B 21/182

(57) ABSTRACT

Systems, apparatuses, and methods described herein are configured for monitoring and managing a plurality of sensors. The plurality of sensors may be fixed, mobile, or a combination thereof. In some embodiments, the monitoring and management of the sensors is facilitated via a graphical user interface.

### RELATED U.S. APPLICATIONS

This application is related to U.S. patent application Ser. No. 14/281,896 entitled “SENSOR BASED DETECTION SYSTEM”, by Joseph L. Gallo et al., (Attorney Docket No. 13-012-00-US), filed on 20 May 2014, which is incorporated by reference herein.

This application is related to U.S. patent application Ser. No. 14/281,901 entitled “SENSOR MANAGEMENT AND SENSOR ANALYTICS SYSTEM”, by Joseph L. Gallo et al., (Attorney Docket No. 13-013-00-US), filed on 20 May 2014, which is incorporated by reference herein.

This application is related to U.S. patent application Ser. No. ______ entitled “METHOD AND SYSTEM FOR SENSOR ASSOCIATED MESSAGING”, by Joseph L. Gallo et al., (Attorney Docket No. 13-015-00-US), filed on ______, which is incorporated by reference herein.

This application is related to U.S. patent application Ser. No. ______ entitled “PATH DETERMINATION OF A SENSOR BASED DETECTION SYSTEM”, by Joseph L. Gallo et al., (Attorney Docket No. 13-016-00-US), filed on ______, which is incorporated by reference herein.

This application is related to U.S. patent application Ser. No. ______ entitled “GRAPHICAL USER INTERFACE OF A SENSOR BASED DETECTION SYSTEM”, by Joseph L. Gallo et al., (Attorney Docket No. 13-017-00-US), filed on ______, which is incorporated by reference herein.

This application is related to U.S. patent application Ser. No. ______ entitled “GRAPHICAL USER INTERFACE FOR PATH DETERMINATION OF A SENSOR BASED DETECTION SYSTEM”, by Joseph L. Gallo et al., (Attorney Docket No. 13-018-00-US), filed on ______, which is incorporated by reference herein.

This application is related to U.S. patent application Ser. No. 14/281,904 entitled “EVENT MANAGEMENT SYSTEM FOR A SENSOR BASED DETECTION SYSTEM”, by Joseph L. Gallo et al. (Attorney Docket No. 13-020-00-US), filed on 20 May 2014, which is incorporated by reference herein.

This application is related to Philippines Patent Application No. 14/281,904 entitled “A DOMAIN AGNOSTIC METHOD AND SYSTEM FOR THE CAPTURE, STORAGE, AND ANALYSIS OF SENSOR READINGS”, by Ferdinand E. K. de Antoni, (Attorney Docket No. 13-027-00-PH), filed on 23 May 2013, which is incorporated by reference herein.

This application is related to U.S. patent application Ser. No. 14/281,904 entitled “USER QUERY AND GAUGE-READING RELATIONSHIPS”, by Ferdinand E. K. de Antoni (Attorney Docket No. 13-027-00-US) and filed on 21 May 2014, which is incorporated by reference herein.

### BACKGROUND

As technology has advanced, computing technology has proliferated to an increasing number of areas while decreasing in price. Consequently, devices such as smartphones, laptops, GPS, etc., have become prevalent in our community, thereby increasing the amount of data being gathered in an ever increasing number of locations. Unfortunately, most of the information gathered is used for marketing and advertising to the end user, e.g., smartphone user receives a coupon to a nearby Starbucks, etc., while the security of our community is left exposed and at a risk of terrorist attacks such as the Boston Marathon bombers.

### SUMMARY

Accordingly, a need has arisen for a solution to allow monitoring and collection of data from a plurality of sensors and management of the plurality of sensors for improving the security of our communities, e.g., by detecting radiation, etc. Further, there is a need to provide relevant information based on the sensors in an efficient manner to increase security.

Embodiments are operable for visualizing and analyzing sensor data and displaying the sensor data and the analysis in a meaningful manner. Embodiments are configured to receive sensor data (e.g., sensor reading, sensor metadata, etc.), analyze the received sensor data, e.g., sensor readings, analyzed sensor data, a combination of sensor readings and analyzed sensor data, etc., and present the received sensor data (e.g., visually or to an external system) in an understandable manner or format and to direct attention to possibly important received sensor data. Embodiments are operable for filtering received sensor data based on parameters, conditions, heuristics, or any combination thereof, to visually emphasize and report received sensor data that may be of particular importance. Embodiments may determine how sensor readings are related and report related sensor readings, thereby reporting sensor readings that as a group may be significant. It is appreciated that the embodiments are described herein within the context of radiation detection and gamma ray detection merely for illustrative purposes and are not intended to limit the scope.

One embodiment is directed to a method for monitoring and managing sensors. The method includes receiving a parameter defining an event and receiving data associated with a first sensor. In some embodiments, the data associated with the first sensor comprises analyzed sensor data and metadata associated with the first sensor. The method further includes determining whether the event has occurred based on the data associated with the first sensor and in response to determining that the event has occurred, displaying an indicator associated with the event. In some embodiments, the method may further include receiving a selection of the first sensor via a graphical user interface and storing a portion of metadata associated with the first sensor. The portion of the metadata may be a portion of the parameter.

In some embodiments, the parameter is a radiation reading range. In some embodiments, the parameter is selected from the group consisting of a building name, a floor level, a room number, a geospatial coordinates, a distance from a geographical location, and sensor equipment properties. In some embodiments, the parameter comprises a distance between the first sensor and a second sensor. In some embodiments, the parameter further comprises a time interval between a first sensor reading from the first sensor and a second sensor reading from the second sensor. The first sensor may be proximate to the second sensor. The parameter may be based on a rate of travel of an object past the first sensor and the second sensor.

Another embodiment is directed to a method for monitoring and managing sensors. The method includes receiving a plurality of parameters associated with an event and receiving data associated with a plurality of sensors. In some embodiments, the data associated with the plurality of sensors comprises analyzed sensor data and metadata associated with the plurality of sensors. The method further includes determining whether the event has occurred based on the data associated with the plurality of sensors and the plurality of parameters associated with the event and in response to determining that the event has occurred, displaying an indicator associated with the event. In some embodiments, the method may further include receiving a selection of a set of sensors of the plurality of sensors via a graphical user interface and storing a portion of metadata associated with the set of sensors as the parameter associated with the event.

In some embodiments, the plurality of parameters associated with the event comprises a radiation threshold. In some embodiments, the plurality of parameters comprises a distance between the first sensor and a second sensor of the plurality of sensors. In some embodiments, the plurality of parameters further comprises a time interval between a first sensor reading from the first sensor and a second sensor reading from the second sensor. In some embodiments, the plurality of parameters comprises a distance range between a first sensor and a second sensor of the plurality of sensors. In some embodiments, the plurality of parameters associated with the event comprise a rate of travel of an object past a first sensor and a second sensor of the plurality of sensors.

Another embodiment is directed to a system for monitoring and managing sensors. The system includes a parameter module configured to receive a condition for defining an event and a data module configured to receive data associated with a plurality of sensors. The system further includes an event determination module configured to determine whether the event has occurred based on the data associated with the plurality of sensors and a visualization module configured to output of an indicator based on occurrence of the event. The system may further include a messaging module configured to send an indicator associated with the event. In some embodiments, the condition associated with the event comprises a set of readings from the plurality of sensors varying outside a specified limit.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows an exemplary operating environment of an exemplary sensor based detection system in accordance with one embodiment.

FIG. 2 shows an exemplary data flow diagram in accordance with one embodiment.

FIG. 3 shows an exemplary flow diagram of a process for representing data from a sensor in accordance with one embodiment.

FIG. 4 shows an exemplary flow diagram of a process for representing data from a plurality of sensors in accordance with one embodiment.

FIG. 5 shows a block diagram of an exemplary graphical user interface configured for displaying sensor associated information with its respective geographical context in accordance with one embodiment.

FIG. 6 show a block diagram of an exemplary graphical user interface configured for creating an event in accordance with one embodiment.

FIG. 7 shows a block diagram of an exemplary graphical user interface configured for displaying alert information in accordance with one embodiment.

FIG. 8 shows a block diagram of an exemplary graphical user interface operable for configuring an event in accordance with one embodiment.

FIG. 9 shows a block diagram of an exemplary graphical user interface configured for viewing event details in accordance with one embodiment.

FIG. 10 shows a block diagram of an exemplary graphical user interface operable for viewing event activity logs in accordance with one embodiment.

FIG. 11 shows a block diagram of an exemplary graphical user interface operable for viewing sensor details associated with an event in accordance with one embodiment.

FIG. 12 shows a block diagram of an exemplary graphical user interface configured for adding an event subscription in accordance with one embodiment.

FIG. 13 shows a block diagram of an exemplary graphical user interface operable for configuring an event subscription in accordance with one embodiment.

FIG. 14 shows a block diagram of an exemplary graphical user interface configured for managing an event subscription in accordance with one embodiment.

FIG. 15 shows a block diagram of an exemplary graphical user interface configured for listing event packages in accordance with one embodiment.

FIG. 16 shows a block diagram of an exemplary graphical user interface configured for managing event packages in accordance with one embodiment.

FIG. 17 shows a block diagram of an exemplary graphical user interface configured for sending an event package in accordance with one embodiment.

FIG. 18A shows a block diagram of an exemplary graphical user interface displaying an event package communication in accordance with one embodiment.

FIG. 18B shows a block diagram of an exemplary graphical user interface configured for displaying event packet details in accordance with one embodiment.

FIG. 19 shows a block diagram of an exemplary graphical user interface configured for viewing activity logs in accordance with one embodiment.

FIG. 20 shows a block diagram of an exemplary graphical user interface including exemplary event log entries in accordance with one embodiment.

FIG. 21 shows a block diagram of an exemplary computer system in accordance with one embodiment.

FIG. 22 shows a block diagram of another exemplary computer system in accordance with one embodiment.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended Claims. Furthermore, in the following detailed description numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits are not described in detail so that aspects of the claimed embodiments are not obscured.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “converting,” “transmitting,” “storing,” “determining,” “sending,” “querying,” “providing,” “accessing,” “associating,” “configuring,” “initiating,” “customizing”, “mapping,” “modifying,” “analyzing,” “displaying,” “updating,” “reconfiguring,” “restarting,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data, that are non-transitory. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

### Method and System for Representing Sensor Associated Data

Accordingly, a need has arisen for a solution to allow monitoring and collection of data from a plurality of sensors and management of the plurality of sensors for improving the security of our communities, e.g., by detecting radiation, bio-hazards, etc. Further, there is a need to provide relevant information based on the sensors in an efficient manner to increase security.

Embodiments are operable for visualizing and analyzing sensor data and displaying the sensor data and the analysis in a meaningful manner. Embodiments are configured to receive sensor data (e.g., sensor reading, sensor metadata, etc.), analyze the received sensor data, e.g., sensor readings, analyzed sensor data, a combination of sensor readings and analyzed sensor data, etc., and present the received sensor data (e.g., visually or to an external system) in an understandable manner or format and to direct attention to possibly important received sensor data. Embodiments are operable for filtering received sensor data based on parameters, conditions, heuristics, or any combination thereof, to visually emphasize and report received sensor data that may be of particular importance. Embodiments may determine how sensor readings are related and report related sensor readings, thereby reporting sensor readings that as a group may be significant. It is appreciated that the embodiments are described herein within the context of radiation detection and gamma ray detection merely for illustrative purposes and are not intended to limit the scope.

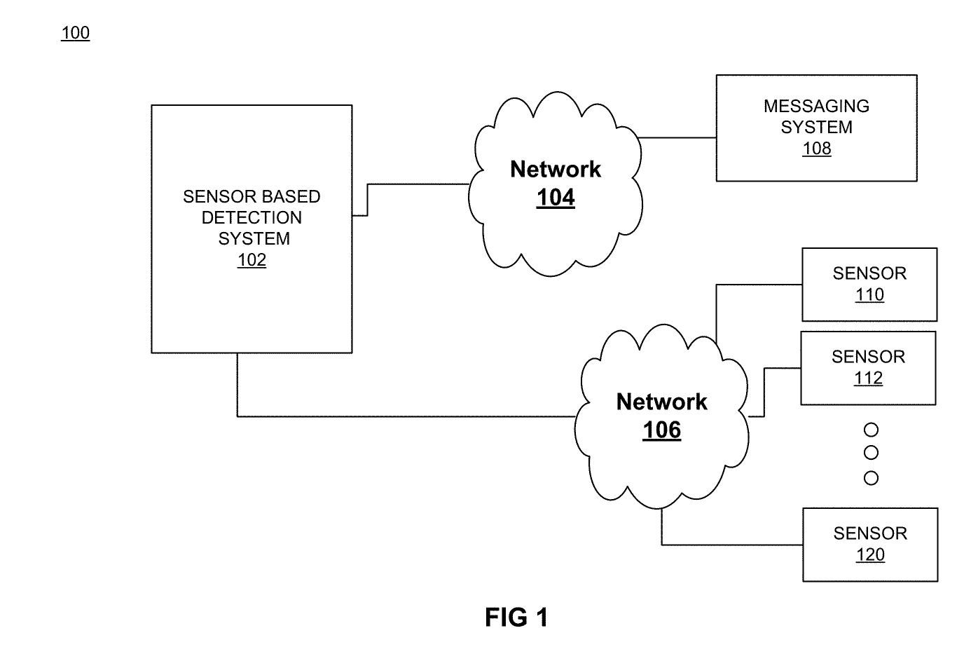

FIG. 1 shows an exemplary operating environment in accordance with one embodiment. The exemplary operating environment 100 includes a sensor based detection system 102, a network 104, a network 106, a messaging system 108, and sensors 110-120. The sensor based detection system 102 and the messaging system 108 are coupled to a network 104. The sensor based detection system 102 and messaging system 108 are communicatively coupled via the network 104. The sensor based detection system 102 and sensors 110-120 are coupled to a network 106. The sensor based detection system 102 and sensors 110-120 are communicatively coupled via network 106. Networks 104, 106 may include more than one network (e.g., intranets, the Internet, local area networks (LAN)s, wide area networks (WAN)s, etc.) and may be a combination of one or more networks including the Internet. In some embodiments, network 104 and network 106 may be a single network.

The sensors 110-120 detect a reading associated therewith, e.g., gamma radiation, vibration, etc., and transmit that information to the sensor based detection system 102 for analysis. The sensor based detection system 102 may use the received information and compare it to a threshold value, e.g., historical values, user selected values, etc., in order to determine whether a potentially hazardous event has occurred. In response to the determination, the sensor based detection system 102 may transmit that information to the messaging system 108 for appropriate action, e.g., emailing the appropriate personnel, sounding an alarm, tweeting an alert, alerting the police department, alerting homeland security department, etc. Accordingly, appropriate actions may be taken in order to avert the risk.

The sensors 110-120 may be any of a variety of sensors including thermal sensors (e.g., temperature, heat, etc.), electromagnetic sensors (e.g., metal detectors, light sensors, particle sensors, Geiger counter, charge-coupled device (CCD), etc.), mechanical sensors (e.g. tachometer, odometer, etc.), complementary metal-oxide-semiconductor (CMOS), biological/chemical (e.g., toxins, nutrients, etc.), etc. The sensors 110-120 may further be any of a variety of sensors or a combination thereof including, but not limited to, acoustic, sound, vibration, automotive/transportation, chemical, electrical, magnetic, radio, environmental, weather, moisture, humidity, flow, fluid velocity, ionizing, atomic, subatomic, navigational, position, angle, displacement, distance, speed, acceleration, optical, light imaging, photon, pressure, force, density, level, thermal, heat, temperature, proximity, presence, radiation, Geiger counter, crystal based portal sensors, biochemical, pressure, air quality, water quality, fire, flood, intrusion detection, motion detection, particle count, water level, surveillance cameras, etc. The sensors 110-120 may be video cameras (e.g., internet protocol (IP) video cameras, network coupled cameras, etc.) or purpose built sensors.

The sensors 110-120 may be fixed in location (e.g., surveillance cameras or sensors, camera, etc.), semi-fixed (e.g., sensors on a cell tower on wheels or affixed to another semi portable object), or mobile (e.g., part of a mobile device, smartphone, etc.). The sensors 110-120 may provide data to the sensor based detection system 102 according to the type of the sensors 110-120. For example, sensors 110-120 may be CMOS sensors configured for gamma radiation detection. Gamma radiation may thus illuminate a pixel, which is converted into an electrical signal and sent to the sensor based detection system 102.

The sensor based detection system 102 is configured to receive data and manage sensors 110-120. The sensor based detection system 102 is configured to assist users in monitoring and tracking sensor readings or levels at one or more locations. The sensor based detection system 102 may have various components that allow for easy deployment of new sensors within a location (e.g., by an administrator, an operator, etc.) and allow for monitoring of the sensors to detect events based on user preferences, heuristics, etc. The events may be used by the messaging system 108 to generate sensor-based alerts (e.g., based on sensor readings above a threshold for one sensor, based on the sensor readings of two sensors within a certain proximity being above a threshold, etc.) in order for the appropriate personnel to take action. The sensor based detection system 102 may receive data and manage any number of sensors, which may be located at geographically disparate locations. In some embodiments, the sensors 110-120 and components of a sensor based detection system 102 may be distributed over multiple systems (e.g., physical machines, virtualized machines, a combination thereof, etc.) and a large geographical area.

The sensor based detection system 102 may track and store location information (e.g., board room B, floor 2, terminal A, etc.) and global positioning system (GPS) coordinates, e.g., latitude, longitude, etc. for each sensor or group of sensors. The sensor based detection system 102 may be configured to monitor sensors and track sensor values to determine whether a defined event has occurred, e.g., whether a detected radiation level is above a certain threshold, whether a detected bio-hazard level is above a certain threshold, etc., and if so then the sensor based detection system 102 may determine a route or path of travel that dangerous or contraband material is taking around or within range of the sensors. For example, the path of travel of radioactive material relative to fixed sensors may be determined and displayed via a graphical user interface. It is appreciated that the path of travel of radioactive material relative to mobile sensors, e.g., smartphones, sensing device, etc., or relative to a mixture of fixed and mobile sensors may similarly be determined and displayed via a graphical user interface. It is appreciated that the analysis and/or the sensed values may be displayed in real-time or stored for later retrieval.

The sensor based detection system 102 may display a graphical user interface (GUI) for monitoring and managing sensors 110-120. The GUI may be configured for indicating sensor readings, sensor status, sensor locations on a map, etc. The sensor based detection system 102 may allow review of past sensor readings and movement of sensor detected material or conditions based on stop, play, pause, fast forward, and rewind functionality of stored sensor values. The sensor based detection system 102 may also allow viewing of an image or video footage (e.g., motion or still images) corresponding to sensors that had sensor readings above a threshold (e.g., based on a predetermined value or based on ambient sensor readings). For example, a sensor may be selected in a GUI and video footage associated with an area within a sensor's range of detection may be displayed, thereby enabling a user to see an individual or person transporting hazardous material. According to one embodiment the footage is displayed in response to a user selection or it may be displayed automatically in response to a certain event, e.g., sensor reading associated with a particular sensor or group of sensors being above a certain threshold.

In some embodiments, sensor readings of one or more sensors may be displayed on a graph or chart for easy viewing. A visual map-based display depicting sensors may be displayed with the sensor representations and/or indicators, which may include color coding, shapes, icons, flash rate, etc., according to the sensors' readings and certain events. For example, gray may be associated with a calibrating sensor, green may be associated with a normal reading from the sensor, yellow may be associated with an elevated sensor reading, orange associated with a potential hazard sensor reading, and red associated with a hazard alert sensor reading.

The sensor based detection system 102 may determine alerts or sensor readings above a specified threshold (e.g., predetermined, dynamic, or ambient based) or based on heuristics and display the alerts in the graphical user interface (GUI). The sensor based detection system 102 may allow a user (e.g., operator, administrator, etc.) to group multiple sensors together to create an event associated with multiple alerts from multiple sensors. For example, a code red event may be created when three sensors or more within twenty feet of one another and within the same physical space have a sensor reading that is at least 40% above the historical values. In some embodiments, the sensor based detection system 102 may automatically group sensors together based on geographical proximity of the sensors, e.g., sensors of gates 1, 2, and 3 within terminal A at LAX airport may be grouped together due to their proximate location with respect to one another, e.g., physical proximity within the same physical space, whereas sensors in different terminals may not be grouped because of their disparate locations. However, in certain circumstances sensors within the same airport may be grouped together in order to monitor events at the airport and not at a more granular level of terminals, gates, etc.

The sensor based detection system 102 may send information to a messaging system 108 based on the determination of an event created from the information collected from the sensors 110-120. The messaging system 108 may include one or more messaging systems or platforms which may include a database (e.g., messaging, SQL, or other database), short message service (SMS), multimedia messaging service (MMS), instant messaging services, Twitter™ available from Twitter, Inc. of San Francisco, Calif., Extensible Markup Language (XML) based messaging service (e.g., for communication with a Fusion center), JavaScript™ Object Notation (JSON) messaging service, etc. For example, national information exchange model (NIEM) compliant messaging may be used to report chemical, biological, radiological and nuclear defense (CBRN) suspicious activity reports (SARs) to report to government entities (e.g., local, state, or federal government).

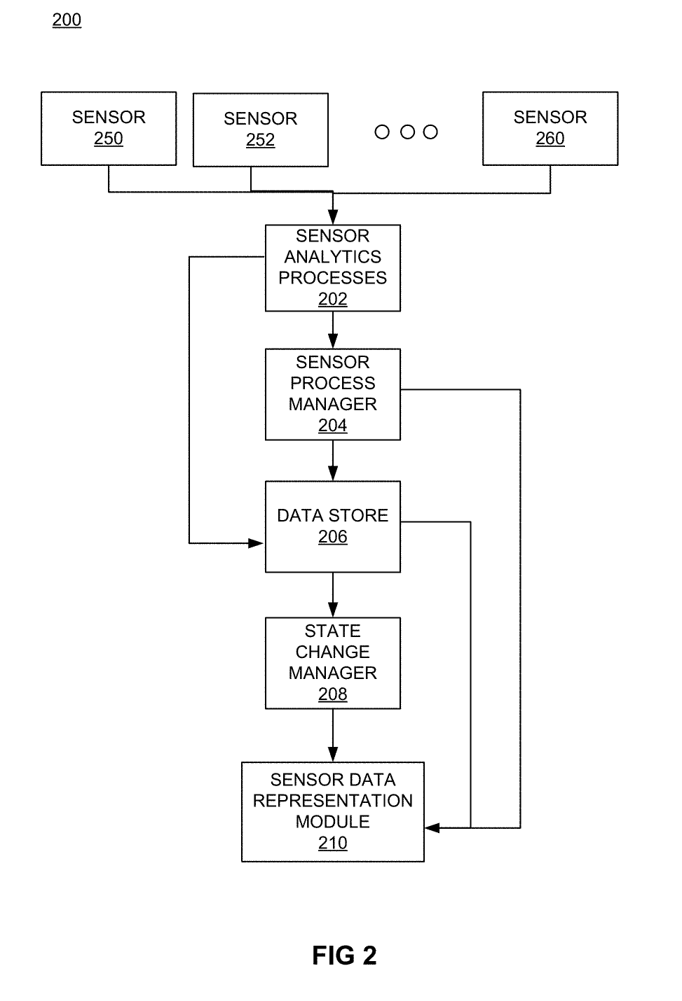

FIG. 2 shows an exemplary data flow diagram in accordance with one embodiment. Diagram 200 depicts the flow of data (e.g., sensor readings, raw sensor data, analyzed sensor data, etc.) associated with a sensor based detection system (e.g., sensor based detection system 102). Diagram 200 includes sensors 250-260, sensor analytics processes 202, a sensor process manager 204, a data store 206, a state change manager 208, and a sensor data representation module 210. In some embodiments, the sensor analytics processes 202, the sensor process manager 204, the state change manager 208, and the sensor data representation module 210 may execute on one or more computing systems (e.g., virtual or physical computing systems). The data store 206 may be part of or stored in a data warehouse.

The sensors 250-260 may be substantially similar to sensors 110-120 and may be any of a variety of sensors as described above. The sensors 250-260 may provide data (e.g., as camera stream data, video stream data, etc.) to the sensor analytics processes 202.

The sensor process manager 204 is configured to initiate or launch sensor analytics processes 202. The sensor process manager 204 is operable to configure each instance or process of the sensor analytics processes 202 based on configuration parameters (e.g., preset, configured by a user, etc.). In some embodiments, the sensor analytics processes 202 may be configured by the sensor process manager 204 to organize sensor readings over particular time intervals (e.g., 30 seconds, one minute, one hour, one day, one week, one year). It is appreciated that the particular time intervals may be preset or it may be user configurable. It is further appreciated that the particular time intervals may be changed dynamically, e.g., during run time, or statically. In some embodiments, a process of the sensor analytics processes 202 may be executed for each time interval. The sensor process manager 204 may also be configured to access or receive metadata associated with sensors 250-260 (e.g., geospatial coordinates, network settings, user entered information, etc.).

The sensor process manager 204 receives analyzed sensor data from sensor analytics processes 202. The sensor process manager 204 may then send the analyzed sensor data to the data store 206 for storage. The sensor process manager 204 may further send metadata associated with sensors 250-260 for storage in the data store 206 with the associated analyzed sensor data. In some embodiments, the sensor process manager 204 may send the analyzed sensor data and metadata to the sensor data representation module 210. In some embodiments, the sensor process manager 204 sends the analyzed sensor data and metadata associated with sensors 250-260 to the sensor data representation module 210. It is appreciated that the information transmitted to the sensor data representation module 210 from the sensor process manager 204 may be in a message based format.

In some embodiments, the sensor analytics processes 202 may then send the analyzed sensor data to the data store 206 for storage. The sensor analytics processes 202 may further send metadata associated with sensors 250-260 for storage in the data store 206 with the associated analyzed sensor data.

The state change manager 208 may access or receive analyzed sensor data and associated metadata from the data store 206. The state change manager 208 may be configured to analyze sensor readings for a possible change in the state of the sensor. It is appreciated that in one embodiment, the state change manager 208 may receive the analyzed sensor data and/or associated metadata from the sensor analytics processes 202 directly without having to fetch that information from the data store 206 (not shown).

The state change manager 208 may determine whether a state of a sensor has changed based on current sensor data and previous sensor data. Changes in sensors state based on the sensor readings exceeding a threshold, within or outside of a range, etc., may be sent to a sensor data representation module 210 (e.g., on a per sensor basis, on a per group of sensors basis, etc.). For example, a state change of the sensor 252 may be determined based on the sensor 252 changing from a prior normal reading to an elevated reading (e.g., above a certain threshold, within an elevated reading, within a dangerous reading, etc.) In another example, the state of sensor 250 may be determine not to have changed based on the sensor 252 having an elevated reading within the same range as the prior sensor reading. In some embodiments, the various states of sensors and associated alerts may be configured by a sensor process manager 204. For example, the sensor process manager 204 may be used to configure thresholds, ranges, etc., that may be compared against sensor readings to determine whether an alert should be generated. For example, the sensors 205-260 may have five possible states: calibrating, nominal, elevated, potential, warning, and danger. It is appreciated that the configuring of the sensor process manager 204 may be in response to a user input. For example, a user may set the threshold values, ranges, etc., and conditions to be met for generating an alert. In some embodiments, color may be associated with each state. For example, dark gray may be associated with a calibration state, green associated with a nominal state, yellow associated with an elevated state, orange associated with a potential state, and red associated with an alert state. Light gray may be used to represent a sensor that is offline or not functioning.

In some embodiments, the state change manager 208 is configured to generate an alert or alert signal if there is a change in the state of a sensor to a new state. For example, an alert may be generated for a sensor that goes from a nominal state to an elevated state or a potential state. In some embodiments, the state change manager 208 includes an active state table. The active state table may be used to store the current state and/or previous and thereby the active state table is maintained to determine state changes of the sensors. The state change manager 208 may thus provide real-time sensing information based on sensor state changes.

In some embodiments, the state change manager 208 may determine whether sensor readings exceed normal sensor readings from ambient sources or whether there has been a change in the state of the sensor and generate an alert. For example, with gamma radiation, the state change manager 208 may determine if gamma radiation sensor readings are from a natural source (e.g., the sun, another celestial source, etc.) or other natural ambient source based on a nominal sensor state, or from radioactive material that is being transported within range of a sensor based on an elevated, potential, warning, or danger sensor state. In one exemplary embodiment, it is determined whether the gamma radiation reading is inside a safe range based on a sensor state of nominal or outside of the safe range based on the sensor state of elevated, potential, warning, or danger.

In some embodiments, individual alerts may be sent to an external system (e.g., a messaging system 108). For example, one or more alerts that occur in a certain building within time spans of one minute, two minutes, or 10 minutes may be sent to a messaging system. It is appreciated that the time spans that the alerts are transmitted may be preset or selected by the system operator. In one embodiment, the time spans that the alerts are transmitted may be set dynamically, e.g., in real time, or statically.

The sensor data representation module 210 may access or receive analyzed sensor data and associated metadata from the sensor process manager 204 or data store 206. The sensor data representation module 210 may further receive alerts (e.g., on a per sensor basis, on per location basis, etc.) based on sensor state changes determined by the state change manager 208.

The sensor data representation module 210 may be operable to render a graphical user interface depicting sensors, sensor state, alerts, sensor readings, etc. The sensor data representation module 210 may display one or more alerts, which occur when a sensor reading satisfies a certain condition visually on a map, e.g., when a sensor reading exceeds a threshold, falls within a certain range, is below a certain threshold, etc. The sensor data representation module 210 may thus notify a user (e.g., operator, administrator, etc.) visually, audibly, etc., that a certain condition has been met by the sensors, e.g., possible bio-hazardous material has been detected, elevated gamma radiation has been detected, etc. The user may have the opportunity to inspect the various data that the sensor analytics processes 202 have generated (e.g. mSv values, bio-hazard reading level values, etc.) and generate an appropriate event case file including the original sensor analytics process 202 data (e.g. raw stream data, converted stream data, preprocessed sensor data, etc.) that triggered the alert. The sensor data representation module 210 may be used (e.g., by operators, administrators, etc.) to gain awareness of any materials (e.g., radioactive material, bio-hazardous material, etc.) or other conditions that travel through or occur in a monitored area.

In some embodiments, the sensor data representation module 210 includes location functionality operable to show a sensor, alerts, and events geographically. The location functionality may be used to plot the various sensors at their respective location on a map within a graphical user interface (GUI). The GUI may allow for rich visual maps with detailed floor plans at various zoom levels, etc. The sensor data representation module 210 may send sensor data, alerts, and events to a messaging system (e.g., messaging system 108) for distribution (e.g., other users, safety officials, etc.).

Alerts from one or more sensors may be grouped, aggregated, represented, and/or indicated as an event. An event may thus be associated with one or more alerts from one or more sensors. The event may be determined based on one or more conditions, rules, parameters, or heuristics applied to one or more alerts. For example, a single alert could be a fluke or a blip in a sensor reading. When multiple alerts occur, however, there is a high likelihood that something more significant is taking place. For example, multiple alerts occurring within the same area or within a certain proximity of one another or facility may indicate that a hazardous material is present in that area. In another example, five alerts that happen within the preceding one minute within the same building and on the same floor may be aggregated into an event. The event may then be sent to an external system or highlighted on a graphical user interface.

In some embodiments, an operator may be able to mark an alert, or series of alerts, as an “event.” The sensor data representation module 210 may allow a user (e.g., operator, administrator, etc.) to group multiple sensors together, e.g., via a text block field, via a mouse selection, via a dropdown menu, etc., to create an event associated with multiple alerts from a group of selected sensors. For example, a code red event may be created when three sensors or more within twenty feet of one another and within the same physical space have a sensor reading that is at least 40% above historical values. In some embodiments, the sensor based detection system 102 may automatically group sensors together based on the geographical proximity of the sensors, e.g., the sensors of gates 1, 2, and 3 within terminal A at LAX airport may be grouped together due to their proximate location with respect to one another, e.g., physical proximity within the same physical space, whereas sensors in different terminals are not grouped because of their disparate locations. However, in certain circumstances sensors within the same airport may be grouped together in order to monitor events at the airport as a whole and not at more granular level of terminals, gates, etc. It is further appreciated that other criteria may be used to group sensors and events together, e.g., sensor types, sensor readings, sensor proximity relative to other sensors, sensor locations, common paths in a structure past sensors, etc.

Representation of sensors (e.g., icons, images, shapes, rows, cells, etc.) may be displayed on a map and be operable for selection to be associated with an event. For example, five alerts with respect to five associated sensors within a particular vicinity may be displayed and an operator may select (e.g., highlight, click on, etc.) the five sensors (e.g., via lasso selection, click and drag selection, click selection, etc.) to group the sensors as an event. Alerts from the five sensors may then be displayed or sent as an event. A condition may also be applied to the group of five sensors such that an event is triggered based on one or more of the sensors in the group of five sensors satisfying a condition (e.g., reaching particular radiation level, exceeding a range of radiation readings, etc.).

In some embodiments, the sensor data representation module 210 may automatically select sensors to be associated as an event. For example, sensors within a 10 meters radius of each other within the same building can automatically be grouped so that alerts from the sensors will be indicated as an event.

The sensor data representation module 210 may access or receive one or more conditions, parameters, or heuristics via a graphical user interface, as input by an operator for instance, that may be used to configure the sensor process manager 204/state change manager 208 in determining an event. The one or more conditions, parameters, or heuristics may be received via the graphical user interface of a sensor data representation module 210, a sensor process manager 204, state change manager 208. The sensor data representation module 210 may determine whether an event has occurred based on an evaluation (e.g., a comparison, an algorithm, etc.) of the analyzed sensor data, the sensor metadata, and the one or more conditions, parameters, or heuristics. For example, sensors on a particular floor of a building may be selected as an event based on the associated location metadata of the sensors.

In another example, the parameters, conditions, or heuristics may be when metadata of sensors has substantially similar values or is within a range of particular values and/or the sensors are associated within a particular temporal time spans (e.g., number of minutes or hours interval over which sensor data is analyzed). Exemplary parameters may include, but are not limited to, building name, floor level, room number, geospatial coordinates within a given range (e.g., distance between sensors, proximity of sensors, etc.), sensor vendors, sensor type, sensor properties, sensor configuration, etc.

The heuristics may include a geographical range (e.g., sensors within a 20-30 meter range, larger range, etc.) or may be based on the time of travel or distance between particular sensors, etc. For example, if it normally takes people 30 minutes to pass through a security checkpoint then if any sensor within the security checkpoint has an alert state for a one minute interval or for a 30 minute interval an event based on the heuristics may be reported. An elevated or alert sensor state of 30 minutes may correspond to a particularly high radiation level that may be worth further investigation.

The heuristics may further include a distance between the sensors and proximity of the sensors. That is, the heuristics may be based on the time, distance, and proximity of the sensors. For example, if two adjacent sensors are sufficiently distant from each other so that radioactive material does not set off both sensors and a person traveling past the sensors would take at least 10 minutes to walk past both sensors, when alerts are generated based on both sensors in a particular order within 10 minutes, an associated event is generated.

An event and associated parameters, conditions, etc., may be based on the geographic proximity of the sensors. An event may thus allow focusing a user's attention (e.g., operator, administrator, etc.) on particular sensor data for a particular area. Metadata associated with the sensors including location, etc., may be used for event determination. For example, a single sensor based alert may be caused by an abnormality, background radiation, etc., while alerts from three, five, or seven sensors within 10 meters of each other may be indicative of a dangerous condition (e.g., hazardous material, hazardous cloud, etc.) that should be further analyzed or further attention directed thereto.

Based on determining that an event has occurred, an indicator may be output by the sensor data representation module 210. In some embodiments, the indicator may be output visually, audibly, or via a signal to another system (e.g., messaging system 108).

In some embodiments, an event may be configured with a parameter specifying where an event indicator should be sent. For example, an event indicator may be displayed in the GUI or the event indicator may be sent to an external system (e.g., messaging system 108).

The indicator may be based on one or more alerts from one or more sensors or an event based on alerts from multiple sensors. The events may be based on groups of sensors selected manually (e.g., via a GUI, command line interface, etc.) or automatically (e.g., based on an automatic grouping determined by the sensor based detection system 102), or based on heuristics. In some embodiments, the indicator (e.g., alert, event, message, etc.) may be output to a messaging system (e.g., messaging system 108 or messaging module 214). For example, the indicator may be output to notify a person (e.g., operator, administrator, safety official, etc.) or group of persons (e.g., safety department, police department, fire department, homeland security, etc.).

The sensor data representation module 210 may have various tools to “replay” after an event has occurred. The sensor data representation module 210 may further allow an operator to configure the sensor data representation module 210 to send alerts to external entities. For example, the operator can configure an XML interface to forward alerts and events to a local Fusion Center (e.g., of the federal government, another government office, etc.). The operator may further configure an SMS gateway or even a Twitter™ account to send alerts or events to.

In some embodiments, functionality of a sensor based detection system (e.g., sensor based detection system 102) may be invoked upon an event being determined. For example, a message may be sent, a determination of the path of travel of a hazardous material or condition, video displayed associated with sensor readings, an alarm signaled, etc.

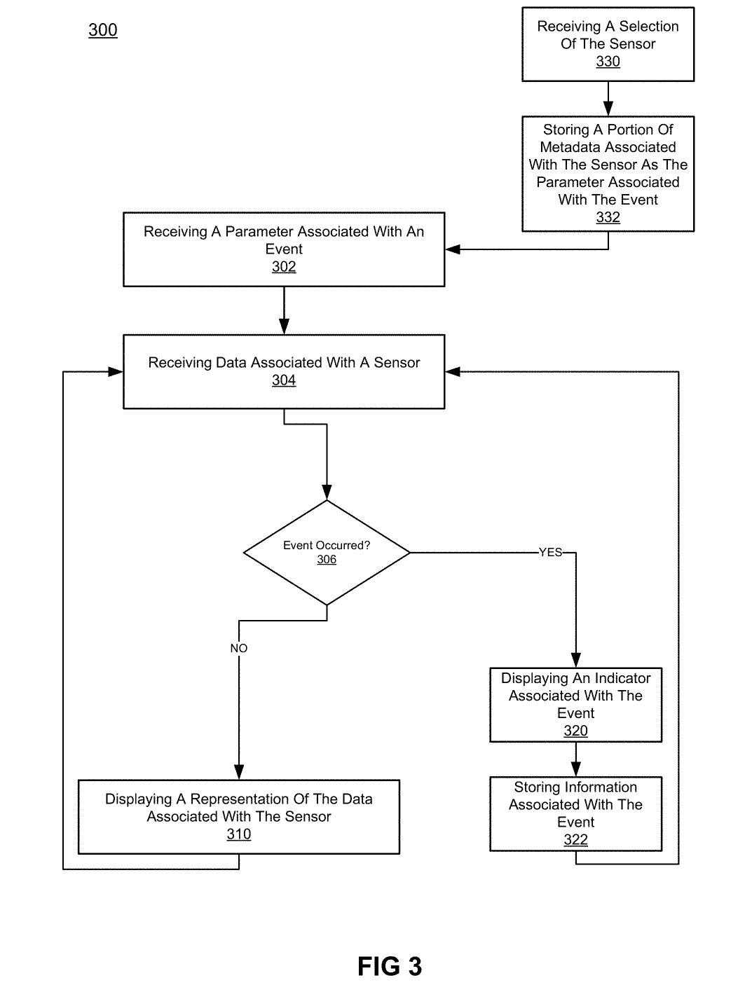

FIG. 3 shows an exemplary flow diagram of a process for representing data from a sensor in accordance with one embodiment. FIG. 3 depicts a process for determining an event based on a parameter and data associated a sensor.

At block 302, a parameter associated with an event is received. The parameter associated with the event may include one or more conditions, heuristics, etc., for evaluating one or more sensor alerts to determine if the event has occurred. It is appreciated that the parameter may be received via a graphical user interface and in response to a user input. It is further appreciated that in some embodiments, the parameter may be received automatically based on sensor information, e.g., sensor type and model, sensor location, sensor range, sensor metadata, etc.

At block 304, data associated with a sensor is received. The data received may be sensor data (e.g., raw sensor data), analyzed sensor data, and/or sensor state change information (e.g., alerts), as described above. Metadata associated with the sensor may further be received (e.g., from a data store, data warehouse, etc.), as described above.

At block 306, whether the event has occurred is determined. Whether the event has occurred may be determined based on receiving sensor associated data, at block 304, and comparing the sensor associated data to the parameter(s) received at block 302. For example, the parameter may be a location of a security check point in an airport and further may be an acceptable radiation reading threshold. The event may be determined to occur when a sensor at the security check point of the airport changes to a warning or danger state, e.g., exceeding the acceptable radiation reading threshold or range.

At block 310, a representation of the data associated with the sensor is displayed. The representation may be associated with the state of the sensor. For example, an icon representing a sensor may be updated from green, which is associated with a nominal sensor reading, to yellow, which is associated with an elevated sensor reading.

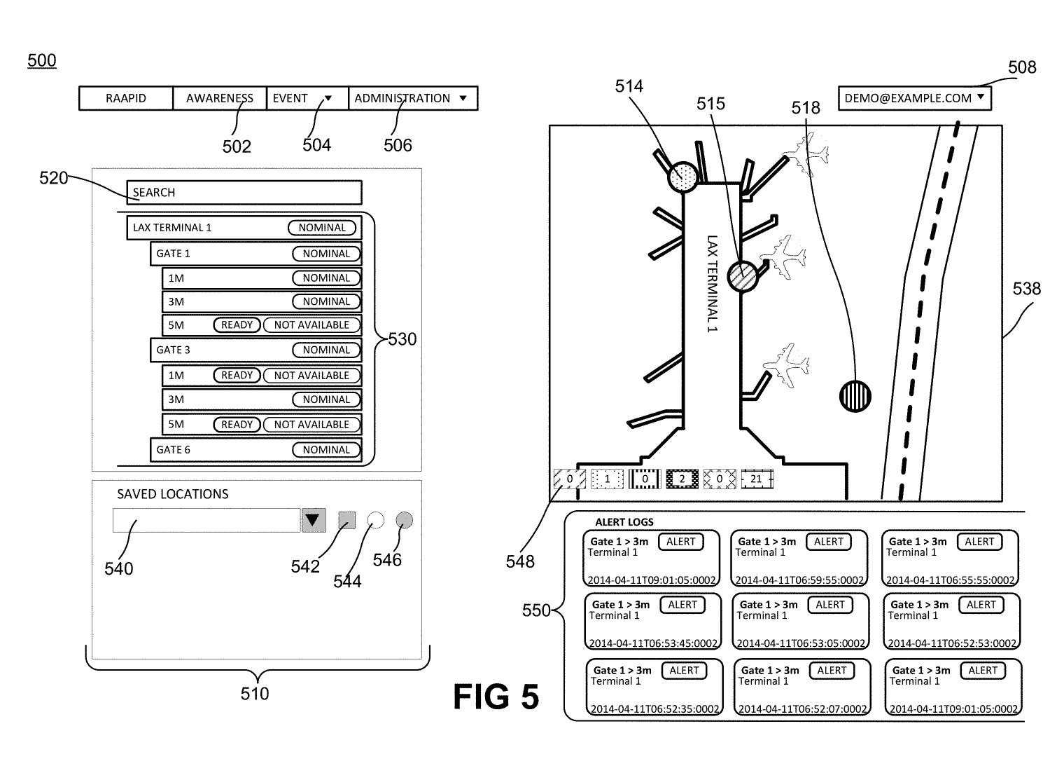

At block 320, an indicator associated with the event is displayed. In some embodiments, the indicator associated with the event may be displayed as a pop-up window, in a status bar, with a flashing or blinking sensor icon, etc. The indicator may further be displayed in an alert area, which displays information (e.g., sensor data, analyzed sensor data, and/or sensor metadata) associated with the alert (e.g., alerts area 550 of FIG. 5). It is appreciated that in one embodiment, a representation of the data associated with the sensor (e.g., sensor readings, raw sensor data, etc.) may be displayed despite an event occurring (not shown) in conjunction with displaying an indicator associated with the event, at block 320.

At block 322, information associated with the event is stored. In some embodiments, the information associated with the event is stored in a non-transitory medium. In some embodiments, a record of the event may be created and stored, which may include time information, sensor location information, sensor data, analyzed sensor data, sensor metadata, or any combination thereof.

At optional block 330, a selection of the sensor is received. In some embodiments, the sensor may be selected via a representation of the sensor (e.g., icon,) in a graphical user interface. For example, the sensor may be selected, at block 330, and a user prompted to enter information to create an event associated with the selected sensor at block 302.

At optional block 332, a portion of metadata associated with the sensor is stored as a parameter associated with the event. For example, a sensor that is at a security checkpoint of an airport may be selected and metadata associated with the sensor including the location (e.g., longitude and latitude) may be stored as the parameter associated with the event. The location parameter may then be used to determine whether other sensors in a particular proximity of the selected sensor have entered an alert state before reporting the event.

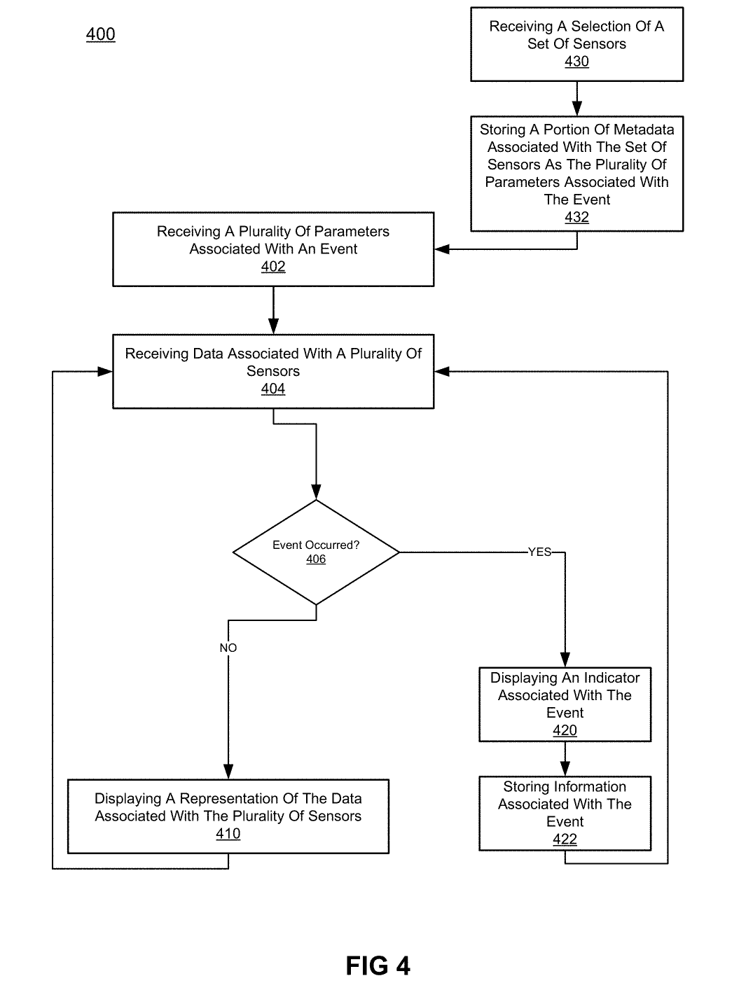

FIG. 4 shows an exemplary flow diagram of a process for representing data from a plurality of sensors in accordance with one embodiment. FIG. 4 depicts a process for determining events based on a plurality of parameters and data associated with a plurality of sensors.

At block 402, a plurality of parameters associated with an event is received. The plurality of parameters associated with the event may include one or more conditions, heuristics, etc. for evaluating one or more sensor alerts to determine if the event has occurred, as described above. It is appreciated that the plurality of parameters may be received via a graphical user interface and in response to a user input. It is further appreciated that in some embodiments, the plurality of parameters may be received automatically based on sensor information, e.g., sensor type and model, sensor location, sensor range, sensor metadata, etc.

At block 404, data associated with a plurality of sensors is received. The data received may be sensor data (e.g., raw sensor data), analyzed sensor data, and/or sensor state change information (e.g., alerts), as described above. Metadata associated with the plurality of sensors may further be received (e.g., from a data store, data warehouse, etc.), as described above.

At block 406, whether the event has occurred is determined. Whether the event has occurred may be determined based on receiving data associated with the plurality of sensors, at block 404, and comparing the data associated with the plurality of sensors to the plurality of parameters received at block 402. For example, the plurality of parameters may be a location of a security checkpoint in an airport and a distance range. An event is determined to occur when one or more sensors at the security checkpoint of the airport within the given distance range change to an alert state e.g., exceeding the acceptable radiation reading threshold, range, etc.

At block 410, one or more representations of the data associated with the plurality of sensors are displayed. The representation may be associated with the states of the plurality of sensors. For example, icons representing the plurality of sensors may be updated from green, which is associated with a nominal sensor reading to yellow, which is associated with an elevated sensor reading.

At block 420, an indicator associated with the event is displayed. In some embodiments, the indicator associated with the event may be displayed as a pop-up window, in a status bar, with a flashing or blinking sensor icon, etc. The indicator may further be displayed in an alert area which displays information (e.g., sensor data, analyzed sensor data, and/or sensor metadata) associated with the alert (e.g., alerts area 550 of FIG. 5). It is appreciated that in one embodiment, a representation of the data associated with the sensor (e.g., sensor readings, raw sensor data, etc.) may be displayed despite an event occurring (not shown) in conjunction with displaying an indicator associated with the event, at block 420.

At block 422, information associated with the event is stored. In some embodiments, the information associated with the event is stored in a non-transitory medium. In some embodiments, a record of the event may be created and stored which may include time information, sensor location information, sensor data, analyzed sensor data, sensor metadata, or any combination thereof.

At optional block 430, a selection of a set of sensors of the plurality of sensors is received. In some embodiments, the set of sensors may be selected via representations of the sensor (e.g., icons) in a graphical user interface. For example, the sensors may be selected, at block 430, via drawing a box around the sensors and a user prompted to enter information to create an event associated with the selected sensors, at block 402.

At optional block 432, a portion of metadata associated with the set of sensors is stored as the plurality of parameters associated with the event. For example, multiple sensors at a security checkpoint of an airport may be selected and any metadata associated with the sensors including location (e.g., longitude and latitude) may be stored as the parameters associated with the event. The location parameters may then be used to determine whether other sensors in a particular proximity or distance range of the selected sensors have entered an alert state before reporting the event.

FIG. 5 shows a block diagram of an exemplary graphical user interface configured for displaying sensor associated information with its respective geographical context in accordance with one embodiment. The exemplary graphical user interface (GUI) 500 includes an awareness button 502, an event menu 504, an administration menu 506, a user icon 508, a locations area 510, a geographical context area 538, and an alerts area 550.

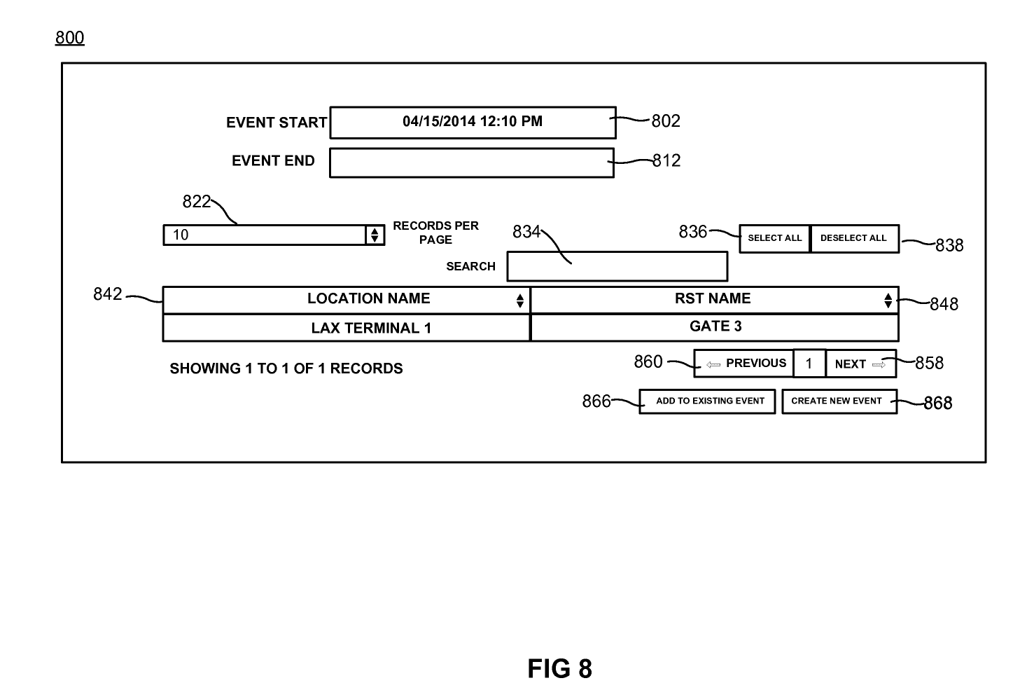

The awareness button 502 is operable for invoking the display of a graphical user interface that may include a locations area 510, a geographical context area 538, and an alerts area 550. The event menu 504 is operable for invoking an event related graphical user interfaces (e.g., FIGS. 8-19). The administration menu 506 may be operable for invoking access to administrative functions for configuring visualization of sensor data and graphical user interface configuration. The user icon 508 is configured for accessing user associated functions (e.g., logout, preferences, etc.). In some embodiments, the user icon 508 may include a username (e.g., email address).

The locations area 510 is operable for selecting, searching, and saving locations. The locations area 510 may include a locations search area 520, a sensor listing area 530, a saved location search area 540, a location saving button 542, a saved location selection button 544, and a saved location removal button 546.

The locations search area 520 allows searching of locations within a sensor based detection system (e.g., sensor based detection system 102). The locations may have been created and configured via a management component of a sensor based detection system and the locations may each have one or more sensors.

The sensor listing area 530 may display a hierarchical view of locations, sensors, and time intervals associated with the sensors. The sensor listing area 530 may further include sensor state indicators, which indicate the sensor state (e.g., as described above) based on the sensor readings. The sensor listing area 530 may list each of the locations within an organization, e.g., within an office building, within a warehouse, within an airport, within a manufacturing floor, etc.

The saved location search area 540 may allow selection (e.g., via a drop down menu or other graphical user interface element) of locations that have been selected and saved previously. The locations may be saved for quick or direct access by an operator and to categorize locations. In some embodiments, a user may be able to select any number of locations and give the selected locations a unique name, which may be used for filtering. In some embodiments, a user may be able to add or remove locations via drag and drop functionality on the map displayed on a graphical user interface.

The location saving button 542 allows a location to be saved to saved locations list (e.g., that is accessible via saved location area 540). The saved location selection button 544 is operable for selecting a saved location for display in the locations listing area 530. The saved location removal button 546 is operable for removing a saved location from the saved locations area 540.

The geographical context area 538 is operable for displaying one or more sensors in a geographical context (e.g., on a map, satellite image, combination thereof, etc.). The geographical context area 538 includes sensor icons 514-518 and a legend 548. The sensor icons 514-518 may each represent a sensor and may be visually represented with a color based on the sensor state (e.g., as described above). The sensor icons 514-518 may represent an aggregated number of sensors. For example, sensor 514 may be an aggregation of five other sensors but represented as one because of zooming out functionality on the map. The sensor icon 514-518 may be selected and in response to a selection, additional sensor information may be displayed including sensor readings (e.g., in mSv), time intervals, sensor state based on the time intervals, metadata associated with the sensor, etc.

The legend 548 is operable for depicting the color coding used for the sensor icons 514-518. In some embodiments, each entry in the legend may be selectable to filter out sensors from the map in a particular alert state. For example, the user (e.g., operator, administrator, etc.) may filter out sensors that are in an Inactive state (e.g., light grey).

The alerts area 550 is operable for displaying alert information. In some embodiments, the alert information includes the location (e.g., gate and terminal), time interval, and time stamp of an alert.

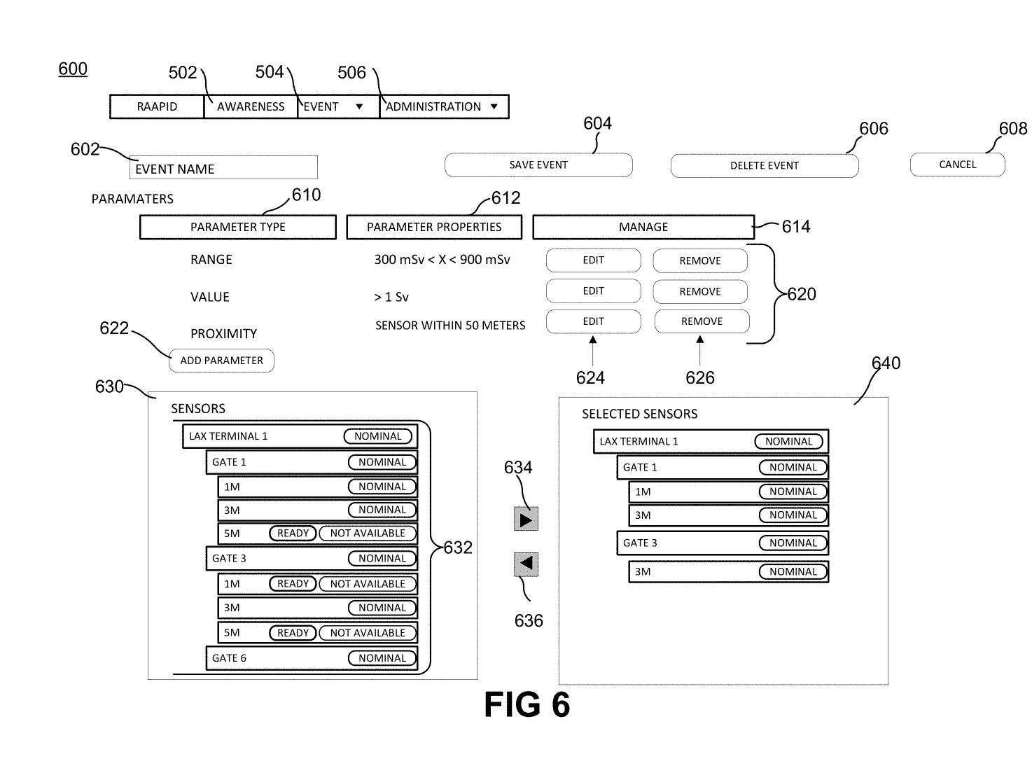

FIG. 6 show a block diagram of an exemplary graphical user interface configured for creating an event in accordance with one embodiment. FIG. 6 depicts an exemplary graphical user interface (GUI) for creating an event, configuring parameters associated with the event, and selecting sensors associated with the event. The exemplary graphical user interface (GUI) 600 includes an event name area 602, a save event button 604, a delete event button 606, a cancel button 608, a parameter type column 610, a parameter properties column 612, a manage column 614, exemplary parameters 620, an add parameter button 622, a sensors list area 630, an add sensors button 634, a remove sensors button 636, and a selected sensors area 640. In some embodiments, exemplary graphical user interface 600 may be displayed in response to selecting a create event menu item of event menu 504.

The event name area 602 is operable for entry and editing of a name to be assigned to an event (e.g., displayed as title label 1024, stored in a data store, etc.). The save event button 604 is operable for invoking functionality to save an event and associated event data. In some embodiments, the event data may include parameters and selected sensors associated with the event as configured via graphical user interface 600.

The delete event button 606 is operable for deleting an event and/or deleting an event that has been partially or completely via exemplary graphical user interface 600. The cancel button 608 is operable for canceling configuration of an event via graphical user interface 600. In some embodiments, another graphical user interface may be displayed (e.g., graphical user interface 900, graphical user interface 500, etc.) in response to activation of cancel button 608.

Exemplary parameters 620 may be displayed with parameter type column 610, parameter properties 612, and manage column 614. The parameter type column 610 is configured for displaying various types of parameters, which may include conditions, rules, heuristics, etc. In some embodiments, the parameters types may include, but are not limited to, a range, a value, or a proximity or distance. The parameter properties column 612 is configured for displaying parameters properties, which may define the parameters for an event based on evaluation with respect to sensor data (e.g., raw sensor data, analyzed sensor data, sensor metadata, etc.). For example, exemplary parameter properties for a range parameter may include a range of 300 mSv to 900 mSv. In another example, exemplary parameter properties for a value parameter may be greater than or equal to 1 Sv (or 1000 mSv). In another example, exemplary parameter properties for a proximity parameter may be sensors within 50 meters, sensors within the same location, etc. It is appreciated that the embodiments are described herein within the context of radiation detection and gamma ray detection merely for illustrative purposes and are not intended to limit the scope.

The manage column 614 is operable for displaying buttons or other elements for managing of parameters and parameter properties. In some embodiments, manage column 614 includes edit buttons 624 and remove buttons 626. Edit buttons 624 are configured for allowing a user to edit parameter types and parameter properties (e.g., configuring ranges, values, and proximity properties) of an event. Remove buttons 626 are configured for allowing a user to remove a parameter from an event.

The add parameter button 622 is configured for adding a parameter to an event. The sensors list area 630 is configured displaying a list of one or sensors. The selected sensors area 640 is operable for displaying a list of one or more sensors that were selected in sensor area 630 and added to selected sensors area 640 via add sensor button 634. The add sensors button 634 is configured for allowing addition of one or more sensors to an event and in response the sensors are displayed in selected sensors area 640. The remove sensors button 636 is configured for allowing removal of one or more sensors from an event and selected sensors area 640.

The elements of the exemplary graphical user interface 600 having the same reference numerals as exemplary graphical user interface 500 may perform substantially similar functions as described herein with respect to exemplary graphical user interface 500.

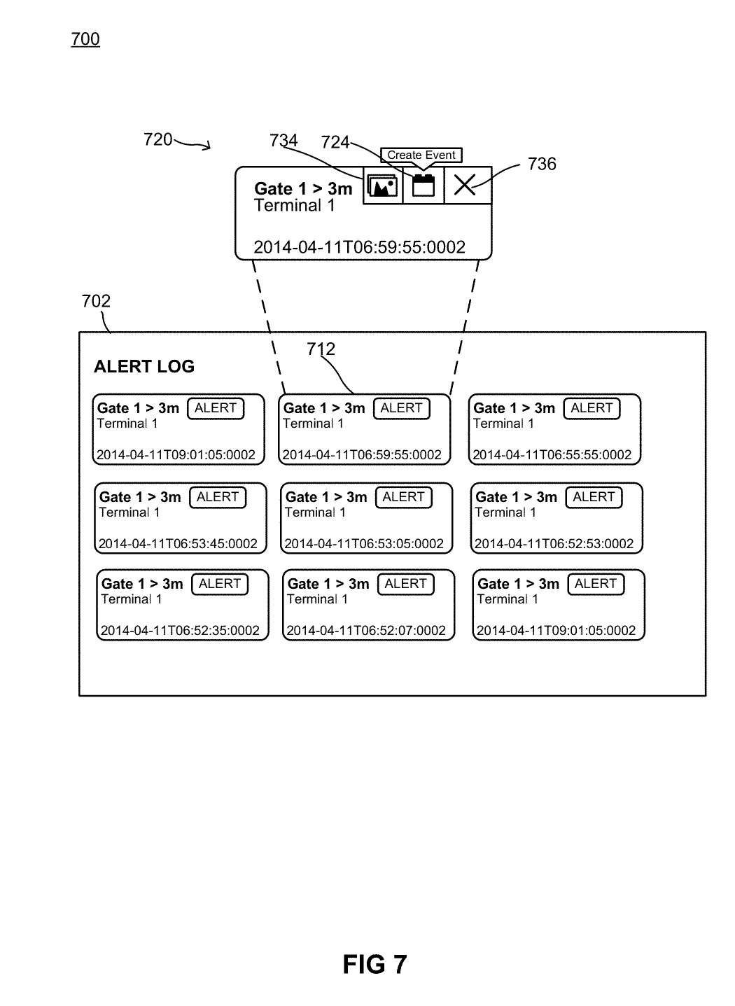

FIG. 7 shows a block diagram of an exemplary graphical user interface configured for displaying alert information in accordance with one embodiment. The exemplary graphical user interface (GUI) 700 depicts a selected alert 712 from an alerts area (e.g., alerts area 550). The exemplary GUI 700 may include an alert log area 702 and a selected alert area 720.

The alerts log area 702 is operable for displaying alert information (e.g., with an alert icon in red). In some embodiments, the alert information includes the location (e.g., gate and terminal), time interval, and time stamp of the alert. The alerts log area 702 may thus provide an overview of the alerts that have been displayed (e.g., on a map, satellite image, etc.). Each of the alerts in the alerts log area 702 may be selectable.

The selected alert area 720 may include the alert information displayed in the alerts log area 702 with three icons 724, 734, and 736. The first icon 724 allows an event to be created based on the selected alert of selected alert area 720. The second icon 734 allows the alert to be visually depicted (e.g., on geographical context area 738). The third icon 736 allows an alert to be removed from the alert log area 702. Embodiments may support creating events based on selection of multiple alerts.

FIG. 8 shows a block diagram of an exemplary graphical user interface operable for configuring an event in accordance with one embodiment. The exemplary graphical user interface (GUI) 800 includes a start time area 802, an end time area 812, a records per page selector 822, a search area 834, a select all button 836, a deselect all button 838, a location column 842, a sensor name column 848, a previous button 860, a next button 858, an add to existing event button 866, and a create new event button 868.

The start time area 802 is operable for configuring a start time of an event (e.g., when an event will become active). The end time area 812 is operable for configure an end time for an event.

In some embodiments, the end time area 812 and an end time for an event may be optional. Events without an end date/time may be considered open-ended and allow the user (e.g., operator, administrator, etc.) to add additional alerts to the events as the alerts happen.

The records per page selector 822 is configured to set the number of records to be displayed per page. In some embodiments, each record may be associated with a sensor or an alert. The search area 834 is configured to invoke a search of sensors to be displayed and is operable for selection. In some embodiments, sensors with alerts may be searched.

The select all button 836 is operable for selection of each of the sensors displayed via the location column 842 and the sensor name column 848. The deselect all button 838 is operable for deselection of each of the sensors displayed via the location column 842 and the sensor name column 848. The location column 842 is operable for displaying locations associated with the sensors displayed in the sensor name column 848. The sensor name column 848 is operable for displaying the names associated with the sensors. In some embodiments, the sensor name column 848 is labeled RST Name or Radiation Sensor Terminal Name.

The previous button 860 is operable for accessing a previous set of sensors based on the records per page selector 822. The next button 858 is operable for accessing a next set of sensors based on the records per page selector 822. The add to existing event button 866 is operable for adding a selected sensor(s) to an existing event. The create new event 868 is operable for invoking creation of an event and the event may then be viewable via the Event menu's 504 view all events menu item.

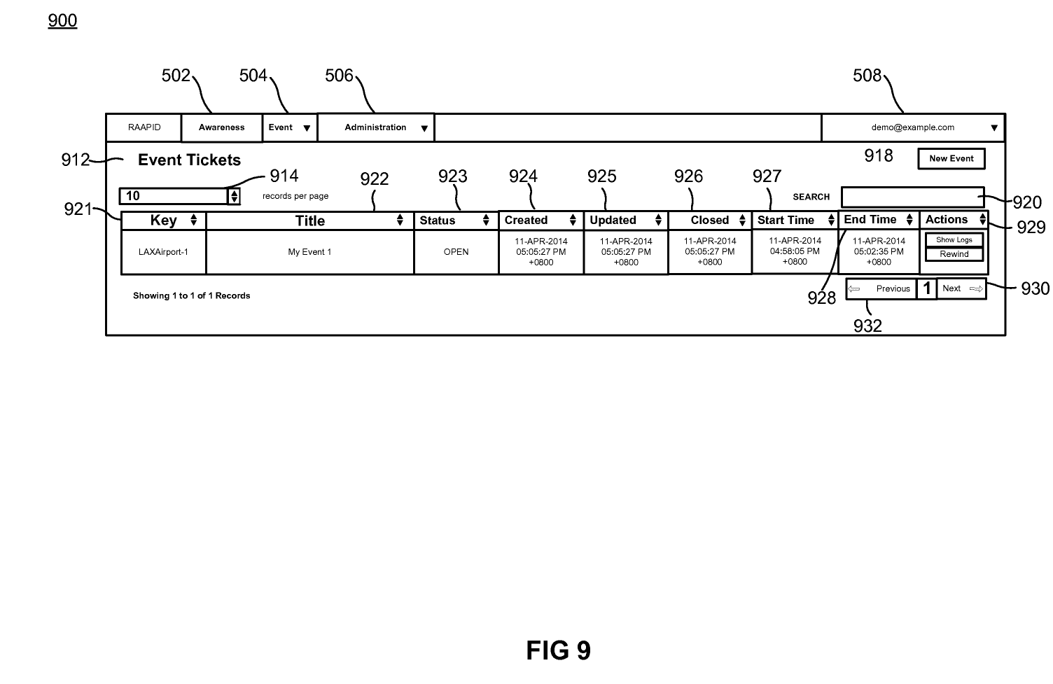

FIG. 9 shows a block diagram of an exemplary graphical user interface configured for viewing event details in accordance with one embodiment. FIG. 9 depicts a graphical user interface (GUI) for viewing an event ticket, which is associated with an event. An event ticket is an object associated with an event that may have a life cycle and may have properties including a status. An event ticket may be used to track and assign an event one or more organizational units (e.g., departments or people). An exemplary GUI 900 includes an event tickets label 912, a new event 918, a records per page selector 914, a key column 921, a title column 922, a status column 923, a created column 924, an updated column 925, a closed column 926, a start time column 927, an end time column 928, an actions column 929, a next button 930, and a previous button 932.

The event tickets label 912 is operable to indicate that one or more event tickets are being displayed. The new event button 918 is operable for creating a new event ticket. The records per page selector 914 is configured to set the number of event tickets to be displayed per page. The key column 921 is operable for displaying a key or unique identifier associated with an event ticket. The title column 922 is operable for displaying a title of an event ticket (e.g., the name of the event). The status column 923 is operable for displaying a status of the event ticket. In some embodiments, the status may be set to open, closed, on hold, or in progress. The created column 924 is operable for displaying the date/time that the event ticket was created. The updated column 925 is operable for displaying the date/time that the event ticket was most recently updated.

The closed column 926 is operable for displaying the date/time that the event ticket was closed. The start time column 927 is operable for displaying the start time of the event associated with the event ticket. The end time column 928 is operable for displaying the end time of the event associated with the event ticket. The actions column 929 is operable for displaying actions (e.g., buttons, drop down items, etc.) associated with the event ticket. In some embodiments, the action column includes a show logs button operable for invoking the display of event logs and a rewind button operable for invoking the display of rewinding of the event, e.g., sensor readings and their respective analyzed data leading to occurrence of the event.

The previous button 932 is operable for accessing a previous next page of event tickets based on the records per page selector 914. The next button 930 is operable for accessing a next page of event set of sensors based on the records per page selector 822.

The elements of the exemplary graphical user interface 900 having the same reference numerals as exemplary graphical user interface 500 may perform substantially similar functions as described herein with respect to exemplary graphical user interface 500.

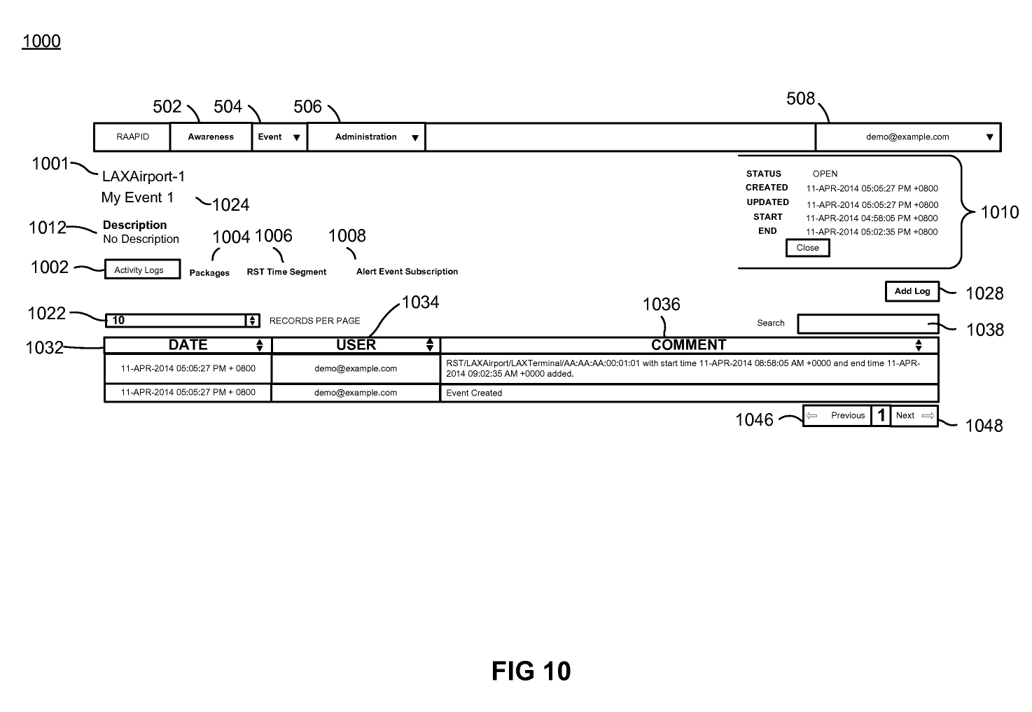

FIG. 10 shows a block diagram of an exemplary graphical user interface operable for viewing an activity logs in accordance with one embodiment. The exemplary graphical user interface (GUI) 1000 includes an event label 1001, a title label 1024, a description area 1012, an activity log button 1002, a packages button 1004, a sensor time segment button 1006, an alert event subscription a button 1008, a status area 1010, a records per page selector 1022, an add log button 1028, a search area 1038, a date column 1032, a user column 1034, a comment column 1036, a previous button 1046, and a next button 1048.

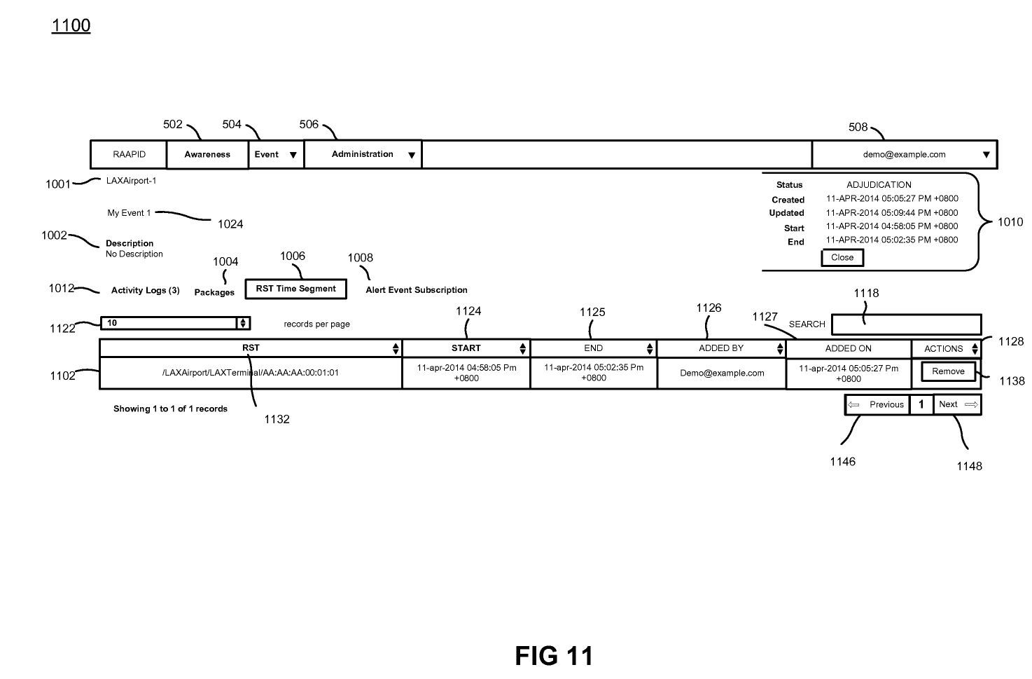

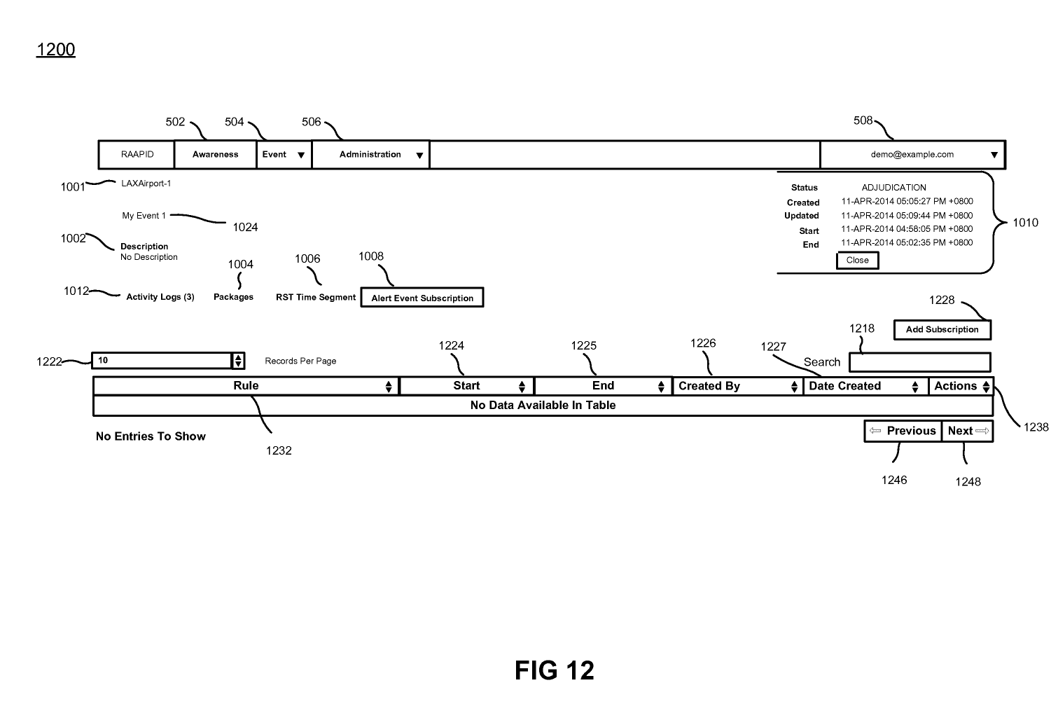

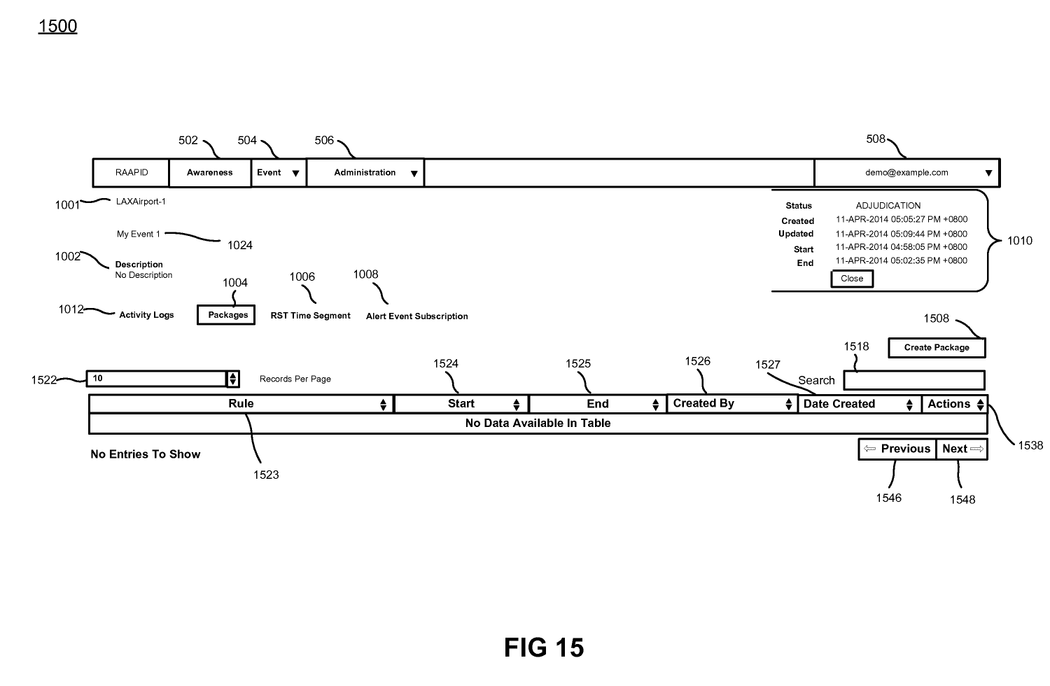

The event label 1001 is operable to indicate the key or other identifier of the event and associated log entries displayed by the exemplary GUI 1000. The title label 1024 is operable to indicate the name of the event that associated log entries are being displayed for. The description area 1012 is operable for displaying a description of an event. The activity log button 1002 is operable for invoking the display of activity log entries associated with an event (e.g., as shown in FIG. 9). The packages button 1004 is operable for invoking the display of a GUI associated with event packages (e.g., FIG. 15). The sensor time segment button 1006 is operable for invoking the display of a graphical user interface associated with sensor time segments (e.g., FIG. 11). The alert event subscription button 1008 is operable for invoking the display of a GUI associated with event subscriptions (e.g., FIG. 12). The status area 1010 is operable for displaying status information of an event ticket. In some embodiments, the status area 1010 may include event ticket status, event ticket creation date/time, event updated date/time, event start date/time, event end date/time, and a close button operable for closing an event ticket.

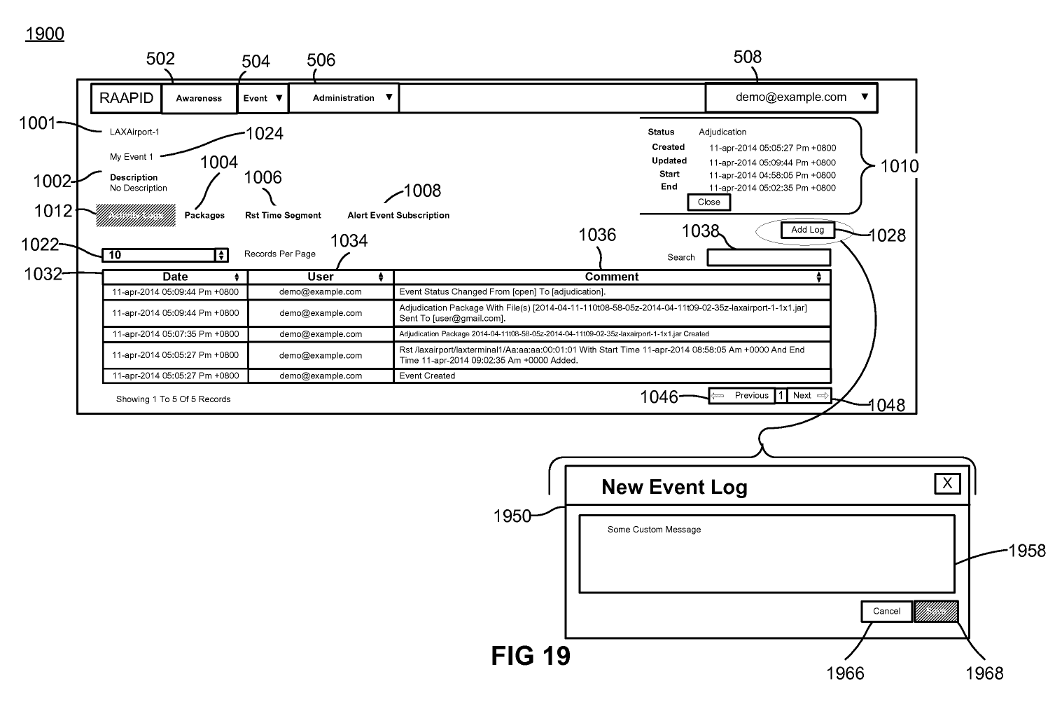

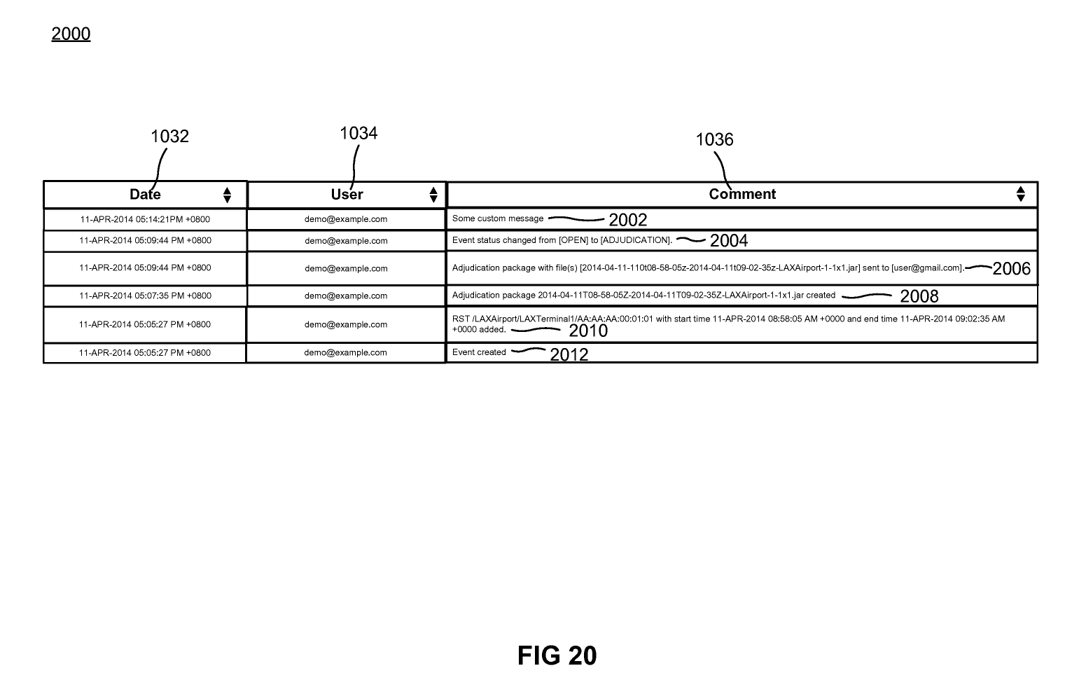

The records per page selector 1022 is configured to set the number of event log records to be displayed per page. In some embodiments, each event log record is associated with an activity (e.g. creation, configuration, update) associated with the event. The add log button 1028 is operable for adding a log entry or record associated with the event (e.g., See FIGS. 19-20). For example, a user may enter custom logs entries with or without custom comment messages. The search area 1038 is operable for searching the log records associated with the event.

The date column 1032 is operable for displaying the date of a log record associated with the event. The user column 1034 is operable for displaying a user associated with the event ticket activities. For example, a user may be assigned an event ticket while other users may perform activities associated with an event ticket, e.g., changing the event ticket status, adding custom messages, etc. The comment column 1036 is operable for displaying comments or notes associated with an event ticket. The previous button 1046 is operable for accessing a previous set of event log records on the records per page selector 1022. The next button 1048 is operable for accessing a next set of event log records based on the records per page selector 1022.

The elements of the exemplary graphical user interface 900 having the same reference numerals as exemplary graphical user interface 500 may perform substantially similar functions as described herein with respect to exemplary graphical user interface 500.

FIG. 11 shows a block diagram of an exemplary graphical user interface operable for viewing sensor details associated with an event in accordance with one embodiment. The exemplary graphical user interface (GUI) 1100 depicts a GUI for displaying a time segment associated with an event ticket. The exemplary graphical user interface 1100 includes a records per page selector 1122, a search area 1118, a sensor column 1132, a start column 1124, an end column 1125, an added by column 1126, an added on column 1127, an actions column 1128, a time segment row 1102, a remove button 1138, a previous button 1146, and a next button 1148. An event may include multiple sensor time segments. A time segment is a duration of time during which a sensor data (e.g., raw sensor data, analyzed sensor data, sensor metadata, etc.) is stored with or associated with an event. For example, an event may have two time segments, one time segment associated with the sensor before the event and the other time segment associated with the sensor after the event. The time segments may be user selected. In some embodiments, an operator may add or remove time segments as desired. In some embodiments, a time segment end date/time may be optional and an event without an end date/time may be considered open-ended.

The records per page selector 1122 is configured to set the number of time segment records to be displayed per page. The search area 1118 is operable for searching the sensor time segments associated with an event ticket. The sensor column 1132 is operable for displaying a sensor identifier (e.g., name, MAC address, etc.). The start column 1124 is operable for displaying a start time of a sensor time segment associated with an event ticket. The end column 1125 is operable for displaying an end time of a sensor time segment associated with an event ticket.

The added by column 1126 is operable for displaying the user that added a time segment to an event ticket. The added on column 1127 is operable for displaying the date/time when a time segment was added to an event ticket. The actions column 1128 is operable for displaying actions associated with an event time segment. The time segment row 1102 includes data corresponding to columns 1124-1132. In some embodiment, the time segment row 1102 may include remove button 1138, which is operable for removing a time segment from an event (e.g., or event ticket, other event tracking object, etc.). The previous button 1146 is operable for accessing a previous set of time segments associated with an event ticket based on the records per page selector 1122. The next button 1148 is operable for accessing a next set of time segments associated with an event ticket based on the records per page selector 1122.

The elements of the exemplary graphical user interface 1100 having the same reference numerals as in exemplary graphical user interface 500 and exemplary graphical user interface 1000 may perform substantially similar functions as described herein with respect to exemplary graphical user interface 500 and exemplary graphical user interface 1000.

FIG. 12 shows a block diagram of an exemplary graphical user interface configured for adding an event subscription in accordance with one embodiment. The exemplary graphical user interface (GUI) 1200 depicts a GUI for the display of alert event subscriptions. In some embodiments, additional time segments can be added (e.g., automatically, dynamically, etc.) through alert event subscriptions. The exemplary GUI 1200 includes an add subscription button 1228, a records per page 1222, a search area 1218, a rule column 1232, a start column 1224, an end column 1225, a created by column 1226, a date created column 1227, an action column 1238, a previous button 1246, and a next button 1248.

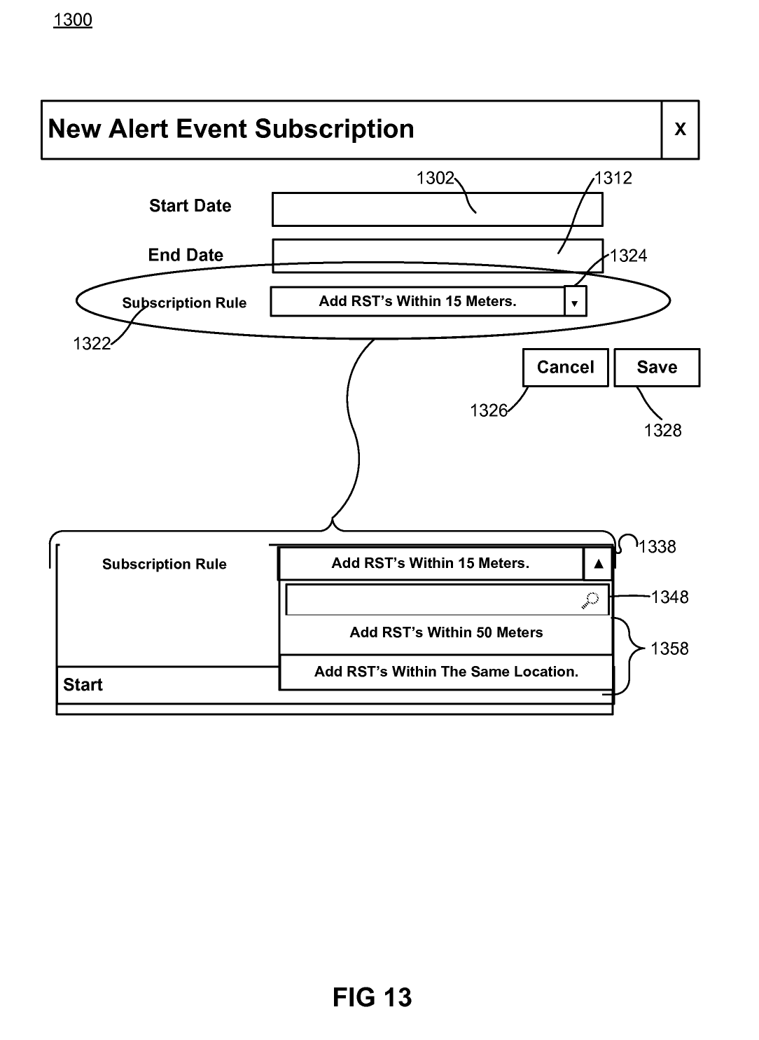

The add subscription button 1228 is operable for invoking the display of a GUI for adding a new subscription (e.g., FIG. 13). The records per page selector 1222 is configured to set the number of alert event subscriptions to be displayed per page. The search area 1218 is operable for searching of alert event subscriptions. The rule column 1232 is operable for displaying one or more rules associated with an alert event subscription. The start column 1224 is operable for displaying a start date and time associated with an alert event subscription. The end column 1225 is operable for displaying an end date/time associated with an alert event subscription. The created by column 1226 is operable for displaying the user or entity that created an alert event subscription. The date created column 1227 is operable for displaying a date/time that an alert event subscription was created. The action column 1238 is operable for displaying actions (e.g., remove) that may be performed for a displayed alert event subscription. The previous button 1246 is operable for accessing a previous set of alert event subscriptions associated with an event ticket based on the records per page selector 1222. The next button 1248 is operable for accessing a next set of alert event subscriptions associated with an event ticket based on the records per page selector 1222.

The elements of the exemplary graphical user interface 1200 having the same reference numerals as in exemplary graphical user interface 500 and exemplary graphical user interface 1000 may perform substantially similar functions as described herein with respect to exemplary graphical user interface 500 and exemplary graphical user interface 1000.

FIG. 13 shows a block diagram of an exemplary graphical user interface operable for configuring an event subscription in accordance with one embodiment. Exemplary graphical user interface (GUI) 1300 depicts a GUI for configuring an event subscription. The exemplary GUI 1300 includes start date area 1302, an end date area 1312, a subscription rule area 1322, a cancel button 1326, and a save button 1328.

The start date area 1302 is operable for setting a start date and/or time of an alert event subscription. The end date area 1312 is operable for setting an end date and/or time of an alert event subscription. The end date and/or time of an alert event subscription may be optional. The subscription rule area 1322 is operable for selecting a rule to be associated with an event and an associated alert event subscription. In some embodiments, the subscription rule area 1322 includes a rule selector area 1324. In some embodiments, upon selection of rule selector area 1324, the rule listing area 1338 may be displayed. The rule listing area 1338 may display a list of rules 1358 and include a search area 1348 operable for searching for rules. The cancel button 1326 is operable for invoking the display of an alert event subscription. The save button 1328 is operable for saving a rule subscription to an event ticket.

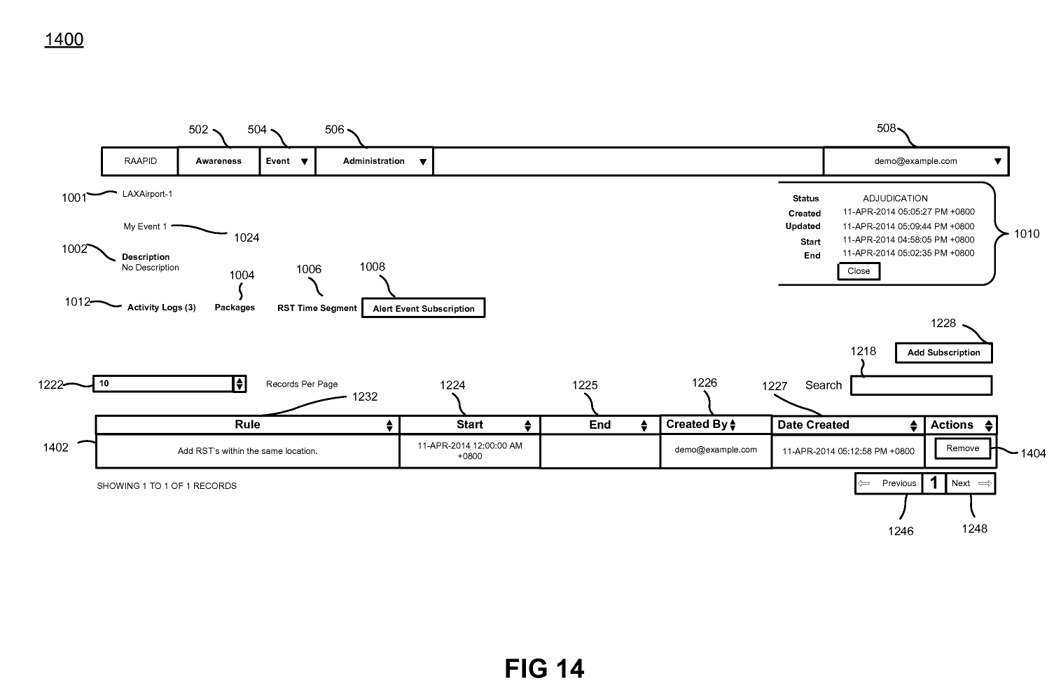

FIG. 14 shows a block diagram of an exemplary graphical user interface configured for managing an event subscription in accordance with one embodiment. The exemplary graphical user interface (GUI) 1400 depicts a GUI after the creation of an alert event subscription (e.g., via FIG. 13). The exemplary GUI 1400 includes an alert event subscription row 1402 and a remove button 1404.

The alert event subscription row 1402 is operable to display the properties of an alert event subscription. As shown alert event subscription row 1402 includes values for the rules column 1232, the start column 1224, the created by column 1226, the date created column 1227 and the remove button 1404 in the actions column 1238. The end column 1225 is shown with a blank value due to the alert event subscription being open-ended, as described above. The remove button 1404 is operable for invoking functionality for removing the alert event subscription of the alert event subscription row 1402.

The elements of the exemplary graphical user interface 1400 having the same reference numerals as in exemplary graphical user interface 500, exemplary graphical user interface 1000, and exemplary graphical user interface 1200 may perform substantially similar functions as described herein with respect to exemplary graphical user interface 500, exemplary graphical user interface 1000, and exemplary graphical user interface 1200.

FIG. 15 shows a block diagram of an exemplary graphical user interface configured for listing event packages in accordance with one embodiment. The exemplary graphical user interface (GUI) 1500 depicts a GUI for viewing information associated with event packages. A package may be created for each event. A package may be used for adjudication purposes and includes raw sensor data from each sensor time segment. The exemplary GUI 1500 includes a create package button 1508, a records per page selector 1522, a search area 1518, a files column 1523, a start column 1524, an end column 1526, a status column 1527, an actions column 1538, a previous button 1546, and a next button 1548.

The create package button 1508 is operable for invoking functionality to create an event package or an adjudication package. In some embodiments, the functionality may include functions to communicate with a sensor process manager (e.g., sensor process manager 204) to collect raw sensor data related to the time segments in the event. The sensor process manager may then collect, package, and make the data available for download or access. A package is collection of any combination of the information of the sensor based system for a purpose. The purpose may include the later retrieval, training, adjudication, prosecution of a criminal, litigation, etc.

The records per page selector 1522 is configured to set the number of event package entries to be displayed per page. The search area 1518 is operable for searching of event packages. The files column 1523 is operable for displaying one or more files names associated with an event package. The start column 1524 is operable for displaying a start date/time of an event package (e.g., the start of sensor based information associated with an event in the event package).

The end column 1526 is operable for displaying an end date/time of an event package (e.g., the end of sensor based information associated with an event in the event package). The status column 1527 is operable for displaying a status of an event package. In some embodiments, the status column 1527 may have the status value PACKAGED for event packages that are substantially complete or the status value IN PROGRESS for event packages that are in the process of being packaged.

The actions column 1538 is operable for displaying options related to a package. In some embodiments, the options may include viewing the details of an event package or sending the event package (e.g., via email, file transfer, etc.). The previous button 1546 is operable for accessing a previous set of event packages associated with an event ticket based on the records per page selector 1522. The next button 1548 is operable for accessing a next set of event packages associated with an event ticket based on the records per page selector 1522.

The elements of the exemplary graphical user interface 1500 having the same reference numerals as in exemplary graphical user interface 500 and exemplary graphical user interface 1000 may perform substantially similar functions as described herein with respect to exemplary graphical user interface 500 and exemplary graphical user interface 1000.

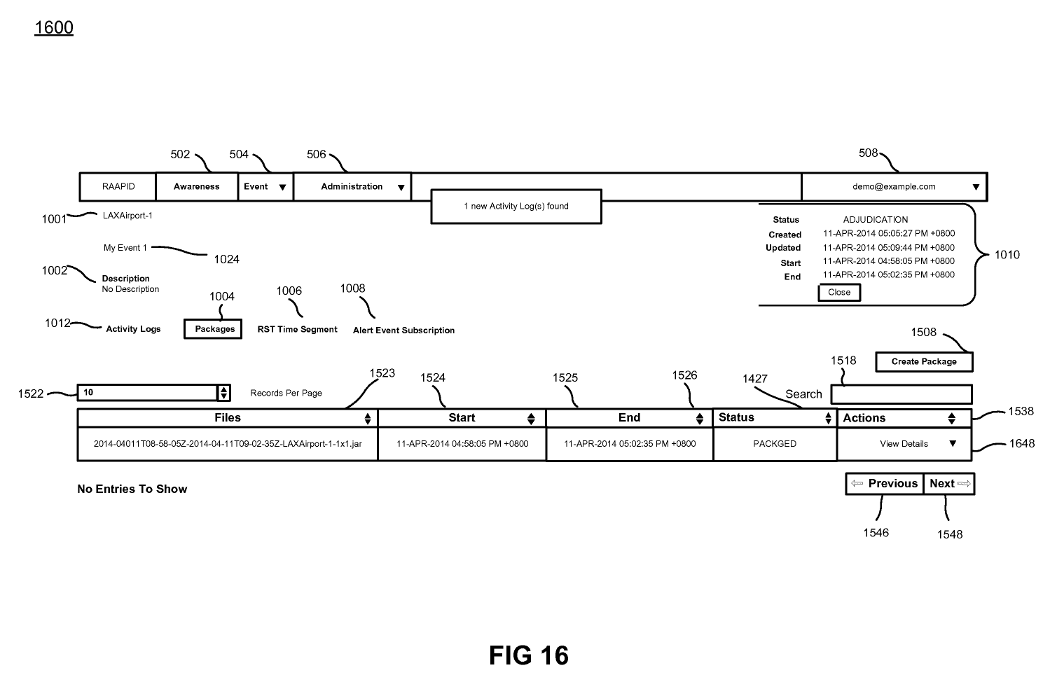

FIG. 16 shows a block diagram of an exemplary graphical user interface configured for managing event packages in accordance with one embodiment. The exemplary graphical user interface (GUI) 1600 depicts an exemplary GUI after the creation of an event package. Exemplary GUI 1600 includes an event package row 1602 and an action button 1648.

The event package row 1602 is operable to display the properties of the event package. As shown, an event package row 1602 includes values for a files column 1522, a start column 1524, an end column 1526, a status column 1527, and an actions column 1538. The actions column 1538 includes a button 1648 for launching functionality to view the details of an event package and other actions.

The elements of the exemplary graphical user interface 1600 having the same reference numerals as in exemplary graphical user interface 500, exemplary graphical user interface 1000, and exemplary graphical user interface 1500 may perform substantially similar functions as described herein with respect to exemplary graphical user interface 500, exemplary graphical user interface 1000, and exemplary graphical user interface 1500.

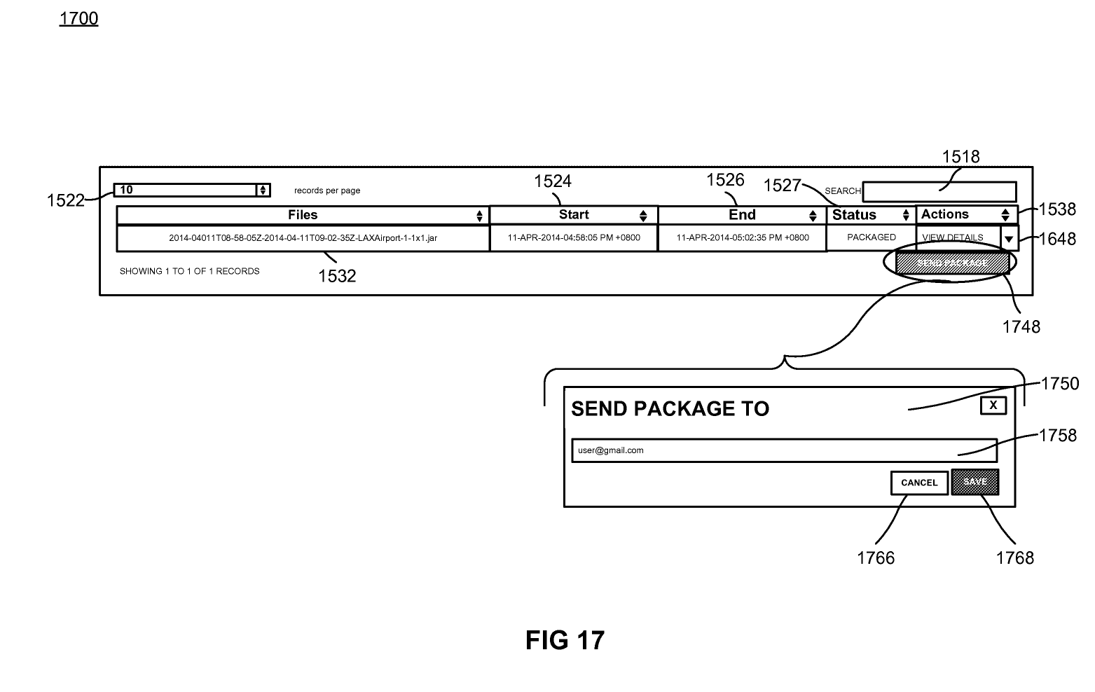

FIG. 17 shows a block diagram of an exemplary graphical user interface configured for sending an event package in accordance with one embodiment. The exemplary graphical user interface (GUI) 1700 depicts additional actions including sending an event package. The exemplary GUI 1700 includes a send package option 1748 and a send package window 1750.

A portion of the actions button 1648 may be selected and the send package menu item 1748 displayed. The send package menu item 1748 is operable for invoking display of send package window 1750. The send package window 1750 is operable for invoking sending of an event package to an email address or some other destination/location (e.g., fileserver, archival system, etc.). The send package window 1750 includes an email address area 1758, a cancel button 1766, and a save button 1768. The email address area 1758 is operable for entering and editing of an email address. The save button 1768 is operable for invoking sending the event package to the location entered in the email address area 1758. The cancel button 1766 is operable for invoking display of an event package GUI (e.g., FIG. 16). It is appreciated that sending of event packages via email is illustrative and non-limiting. For example, the event packages may be faxed, printed, displayed, etc.

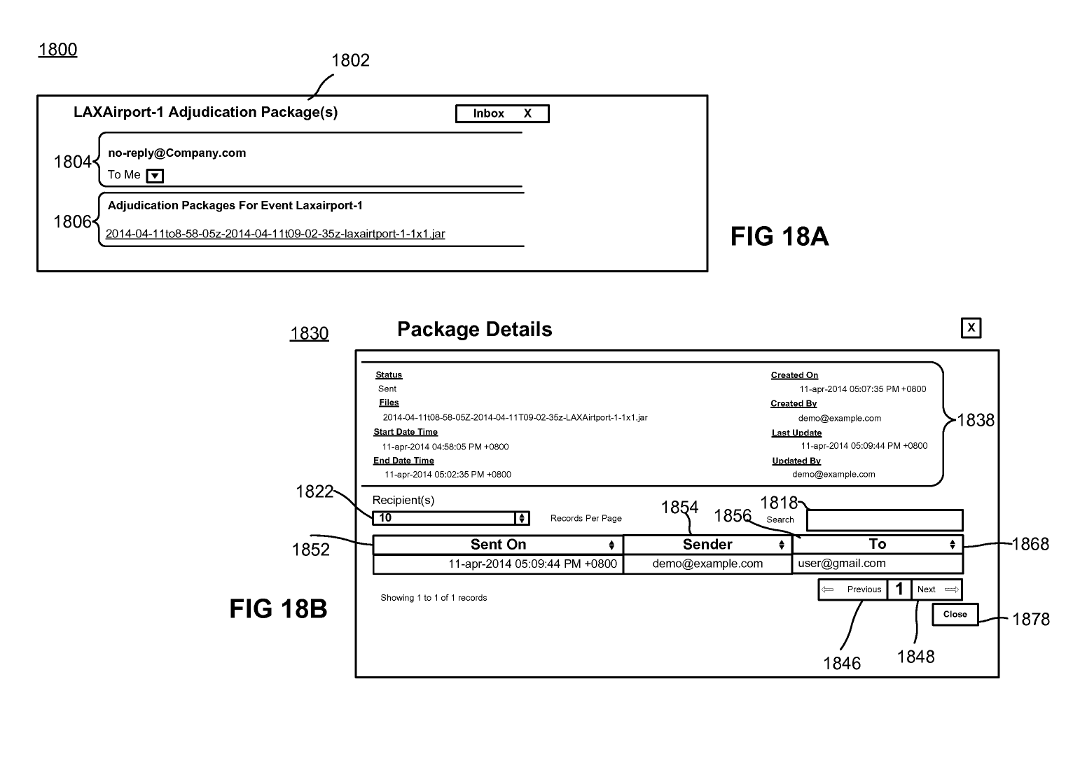

FIG. 18A shows a block diagram of an exemplary graphical user interface displaying an event package communication in accordance with one embodiment. The exemplary graphical user interface (GUI) 1800 depicts an email with an event package link. The exemplary GUI 1800 includes an email subject 1802, sender and recipient information 1804, and a message 1806. The email subject 1802 may include a key or other identifier associated with an event. The sender and recipient information 1804 may indicate the sender and recipient of the email. The message 1806 may include the event name and a link (e.g., hyperlink, file transfer protocol (FTP) link) to event package, thereby enabling the recipient to download the event package.

FIG. 18B shows a block diagram of an exemplary graphical user interface configured for displaying event package details in accordance with one embodiment. The exemplary graphical user interface (GUI) 1830 depicts package details including to whom a package has been sent. In some embodiments, the exemplary GUI 1830 may be displayed in response to selection of the view details option in actions column 1438. The exemplary GUI 1830 includes package details 1838, a records per page selector 1822, a search area 1818, a sent on column 1852, a sender column 1854, a to column 1856, a previous button 1846, a next button 1848, and a close button 1878.

The package details 1838 may include a package status (e.g., SENT, NOT SENT, IN PROGRESS, etc.), file names of the packages, a start date/time of the event package, an end date/time of the event package, a created on date/time, created by (e.g., username, email address, etc.), a last update date/time, and an updated by (e.g., username, email address, etc.).

The records per page selector 1822 is configured to set the number of event package sent records to be displayed per page. The search area 1818 is operable for searching of event package details.

The sent on column 1852 is operable for displaying a date/time that an event package was sent. The sender column 1854 is operable for displaying the sender (e.g., username, email address, etc.) that initiated the sending of the event package. The to column 1856 is operable for displaying a destination (e.g., username, email address, etc.) where an event package or a pointer (e.g., link) to an event package was sent.

The previous button 1846 is operable for accessing a previous set of event package details based on the records per page selector 1822. The next button 1848 is operable for accessing a next set of event package details based on the records per page selector 1822. The close button 1878 is operable for closing the exemplary graphical user interface 1830.

FIG. 19 shows a block diagram of an exemplary graphical user interface configured for viewing activity logs in accordance with one embodiment. The exemplary graphical user interface (GUI) 1900 may be displayed upon selection of an add log button 1028 which allows a user to add custom log messages.

The exemplary GUI 1900 includes a new event log window 1950. The new event log window 1950 includes a custom message area 1958, a cancel button 1966, and a save button 1968. The custom message area 1958 is operable for entering and editing of text or other information to be added to an event log. The save button 1968 is operable for invoking saving of data in the custom message area 1958 to the activity logs associated with an event. The cancel button 1966 is operable to close a new event log window 1950.

The elements of the exemplary graphical user interface 1800 having the same reference numerals as in exemplary graphical user interface 500 and exemplary graphical user interface 1000 may perform substantially similar functions as described herein with respect to exemplary graphical user interface 500 and exemplary graphical user interface 1000.

FIG. 20 shows a block diagram of an exemplary graphical user interface including exemplary event log entries in accordance with one embodiment. FIG. 19 depicts exemplary event log entries that may include automatic event log entries (e.g., generated by sensor based detection system 102) and custom log entries (e.g., created via a new event log window 1950). The exemplary graphical user interface (GUI) 2000 includes a date column 1032, a user column 1034, a comments column 1036, and exemplary log entries 2002-2012.

The exemplary log entry 2002 shows an exemplary custom message log entry (e.g., created via new event log window 2050). The exemplary log entry 2004 shows an exemplary status change log entry (e.g., event status change from OPEN to ADJUDICATION). The exemplary log entry 2006 shows an exemplary package sent log entry (e.g., sent via exemplary graphical user interface 1700). The exemplary log entry 2008 shows an exemplary package creation log entry (e.g., created via create package button 1508). The exemplary log entry 2010 shows an event occurrence log entry (e.g., when one or more alerts satisfying or meeting event parameters, conditions, rules, or heuristics). The exemplary log entry 2012 shows an exemplary event creation log entry (e.g., created via exemplary graphical user interface 800).

The elements of the exemplary graphical user interface 2000 having the same reference numerals as in exemplary graphical user interface 900 may perform substantially similar functions as described herein with respect to exemplary graphical user interface 900.

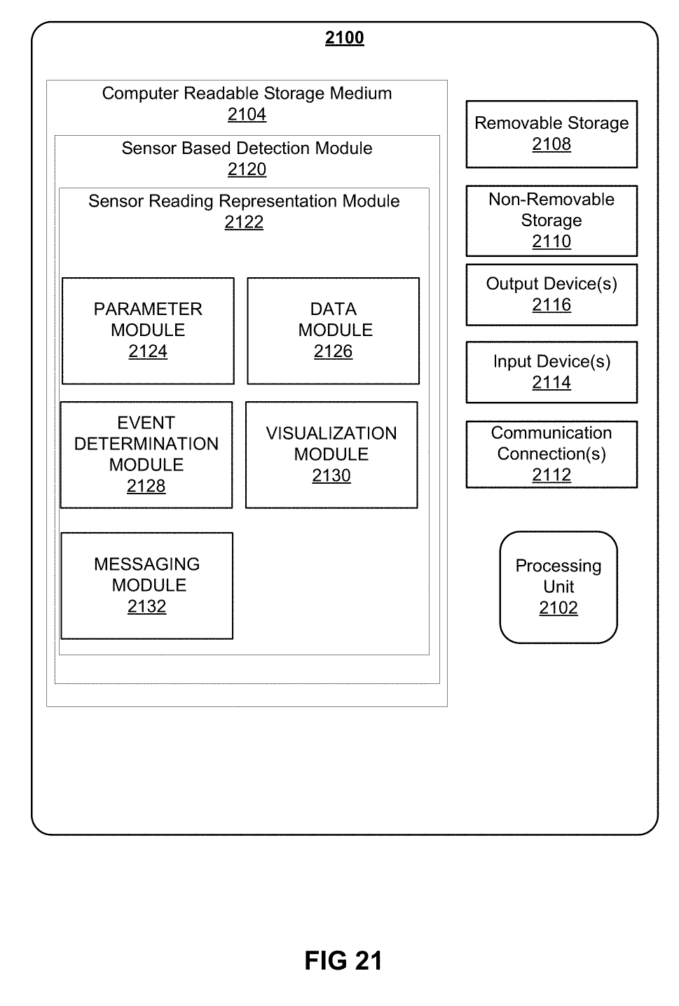

Referring now to FIG. 21, a block diagram of an exemplary computer system in accordance with one embodiment is shown. With reference to FIG. 21, an exemplary system module for implementing embodiments disclosed above, such as the embodiments described in FIGS. 1-20. In some embodiments, the system includes a general purpose computing system environment, such as computing system environment 2100. The computing system environment 2100 may include, but is not limited to, servers, desktop computers, laptops, tablets, mobile devices, and smartphones. In its most basic configuration, the computing system environment 2100 typically includes at least one processing unit 2102 and computer readable storage medium 2104. Depending on the exact configuration and type of computing system environment, computer readable storage medium 2104 may be volatile (such as RAM), non-volatile (such as ROM, flash memory, etc.) or some combination of the two. Portions of computer readable storage medium 2104 when executed facilitate monitoring and management of sensors and sensor analytics processes according to embodiments described above (e.g., processes 300-400).

Additionally in various embodiments, computing system environment 2100 may also have other features/functionality. For example, computing system environment 2100 may also include additional storage (removable and/or non-removable) including, but not limited to, magnetic or optical disks or tape. Such additional storage is illustrated by removable storage 2108 and non-removable storage 2110. Computer storage media includes volatile and nonvolatile, removable and non-removable media implemented in any method or technology for storage of information such as computer readable instructions, data structures, program modules or other data. Computer readable medium 2104, removable storage 2108 and nonremovable storage 2110 are all examples of computer storage media. Computer storage media includes, but is not limited to, RAM, ROM, EEPROM, flash memory or other memory technology, expandable memory (e.g. USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 2100. Any such computer storage media may be part of computing system environment 2100.

In some embodiments, computing system environment 2100 may also contain communications connection(s) 2112 that allow it to communicate with other devices. Communications connection(s) 2112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer readable media as used herein includes both storage media and communication media.

Communications connection(s) 2112 may allow computing system environment 2100 to communicate over various networks types including, but not limited to, fibre channel, small computer system interface (SCSI), Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 2112 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 2100 may also have input device(s) 2114 such as keyboard, mouse, a terminal or terminal emulator (either directly connected or remotely accessible via telnet, SSH, HTTP, SSL, etc.), pen, voice input device, touch input device, remote control, etc. Output device(s) 2116 such as a display, a terminal or terminal emulator (either directly connected or remotely accessible via telnet, SSH, HTTP, SSL, etc.), speakers, LEDs, etc. may also be included.

In one embodiment, the computer readable storage medium 2104 includes sensor based detection module 2120. The sensor based detection module 2120 is configured for monitoring and management of a plurality of sensors and associated analytics (e.g., sensor based detection system 102). The sensor based detection module 2120 includes a sensor reading representation module 2122. The sensor reading representation module 2122 is configured for managing the collection, reporting, and display of sensor readings.

The sensor reading representation module 2122 includes a parameter module 2124, a data module 2126, an event determination module 2128, a visualization module 2130, and a messaging module 2132. The parameter module 2124 is configured to receive one or more conditions, rules, parameters, and heuristics for defining an event, as described above. The condition(s) associated with the event may comprise a set of readings from the plurality of sensors varying outside of a specified limit. The data module 2126 is configured to receive data associated with a plurality of sensors. The event determination module 2128 is configured to determine whether an event has occurred based on the data associated with the plurality of sensors and the conditions associated with an event, as described above. The visualization module 2130 is configured to output an indicator based on the occurrence of the event. The messaging module 2132 is configured to send an indicator associated with the event (e.g., to messaging system 108).

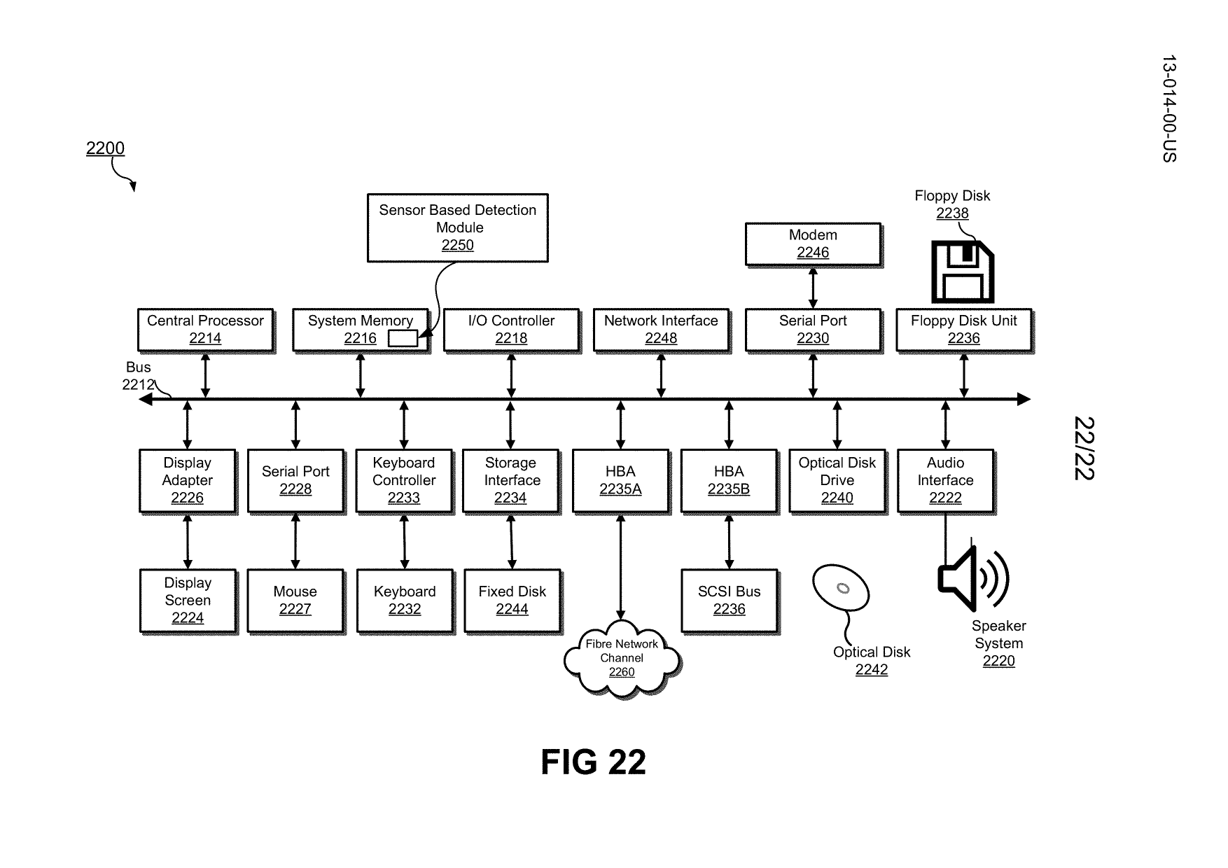

Referring now to FIG. 22, a block diagram of another exemplary computer system in accordance with one embodiment is shown. FIG. 22 depicts a block diagram of a computer system 2200 suitable for implementing the present disclosure. Computer system 2200 includes a bus 2212 which connects the major subsystems of the computer system 2200, such as a central processor 2214, a system memory 2216 (typically RAM, but which may also include ROM, flash RAM, or the like), an input/output controller 2218, an external audio device, such as a speaker system 2220 via an audio output interface 2222, an external device, such as a display screen 2224 via a display adapter 2226, serial ports 2228 and 2230, a keyboard 2232 (interfaced with a keyboard controller 2233), a storage interface 2234, a floppy disk drive 2236 operative to receive a floppy disk 2238, a host bus adapter (HBA) interface card 2235A operative to connect with a Fibre Channel network 2260, a host bus adapter (HBA) interface card 2235B operative to connect to a Small Computer System Interface (SCSI) bus 2236, and an optical disk drive 2240 operative to receive an optical disk 2242. Also included are a mouse 2227 (or other point-and-click device, coupled to bus 2212 via serial port 2228), a modem 2246 (coupled to bus 2212 via serial port 2230), and a network interface 2248 (coupled directly to bus 2212).

It is appreciated that the network interface 2248 may include one or more Ethernet ports, wireless local area network (WLAN) interfaces, etc., but is not limited thereto. System memory 2216 includes a sensor reading representation module 2250 is configured for managing sensor reading collection, sensor reading reporting, and sensor reading display. According to one embodiment, the sensor reading representation module 2250 may include other modules for carrying out various tasks (e.g., modules of FIG. 21). It is appreciated that the sensor reading representation module 2250 may be located anywhere in the system and is not limited to the system memory 2216. As such, residing within the system memory 2216 is merely exemplary and not intended to limit the scope of the embodiments. For example, parts of the sensor reading representation module 2250 may be located within the central processor 2414 and/or the network interface 2448 but are not limited thereto.

The bus 2212 allows data communication between the central processor 2214 and the system memory 2216, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with computer system 2200 are generally stored on and accessed via a computer readable medium, such as a hard disk drive (e.g., fixed disk 2244), an optical drive (e.g., optical drive 2240), a floppy disk unit 2236, or other storage medium. Additionally, applications can be in the form of electronic signals modulated in accordance with the application and data communication technology when accessed via network modem 2246 or network interface 2248.

The storage interface 2234, as with the other storage interfaces of computer system 2200, can connect to a standard computer readable medium for storage and/or retrieval of information, such as a fixed disk drive 2244. A fixed disk drive 2244 may be a part of computer system 2200 or may be separate and accessed through other interface systems. The network interface 2248 may provide multiple connections to networked devices. Furthermore, a modem 2246 may provide a direct connection to a remote server via a telephone link or to the Internet via an Internet service provider (ISP). The network interface 2248 provides one or more connections to a data network, which may consist of any number of other network-connected devices. The network interface 2248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, not all of the devices shown in FIG. 22 need to be present to practice the present disclosure. The devices and subsystems can be interconnected in different ways from that shown in FIG. 22. Code to implement the present disclosure can be stored in computer-readable storage media such as one or more of system memory 2216, fixed disk 2244, optical disk 2242, or floppy disk 2238. The operating system provided on computer system 2200 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings.

1: A method comprising:
receiving a parameter defining an event;
receiving data associated with a first sensor;
determining whether the event has occurred based on: the data associated with the first sensor, and said parameter defining the event; and
in response to determining that the event has occurred, displaying an indicator associated with the event.

2: The method as described in claim 1, wherein the parameter is a radiation reading range for a set location, wherein the parameter further comprises a set distance range from the set location.

3: The method as described in claim 1, wherein the data associated with the first sensor comprises analyzed sensor data and metadata associated with the first sensor, wherein the metadata comprises a location of the first sensor, and wherein determining whether the event has occurred is further based on: received data associated with a plurality of sensors in a set proximity to the location of the first sensor, and said parameter defining the event.

4: The method as described in claim 1 further comprising:
receiving a selection of the first sensor via a graphical user interface; and
storing a portion of metadata associated with the first sensor, wherein the portion of the metadata is a portion of the parameter;
wherein the received data associated with the first sensor is displayed via the graphical user interface by at least one of: a color coding, a shape, and a flashing icons;
wherein the indicator associated with the event is displayed via the graphical user interface by at least one of: a pop-up window, a status bar, and a flashing icon.

5: The method as described in claim 1, wherein the parameter is selected from the group consisting of a building name, a floor level, a room number, a distance from a geographical location, and sensor equipment properties.

6: The method as described in claim 1, wherein the parameter comprises a distance between the first sensor and a second sensor.

7: The method as described in claim 6, wherein the parameter further comprises a time interval between a first sensor reading from the first sensor and a second sensor reading from the second sensor.

8: The method as described in claim 7, wherein the first sensor is proximate to the second sensor.

9: The method as described in claim 8, wherein the parameter is based on a rate of travel of an object past the first sensor and the second sensor.

10: A method comprising:
receiving a plurality of parameters associated with an event, wherein the plurality of parameters defines the event;
receiving data associated with a plurality of sensors;
determining whether the event has occurred based on: the data associated with the plurality of sensors, and the plurality of parameters defining the event; and
in response to determining that the event has occurred, displaying an indicator associated with the event.

11: The method as described in claim 10, wherein the data associated with the plurality of sensors comprises analyzed sensor data and metadata associated with the plurality of sensors, wherein the metadata comprises locations of the plurality of sensors, and wherein determining whether the event has occurred is further based on: received data associated with the plurality of sensors in a set proximity to the locations of the plurality of sensors, and said parameter defining the event.

12: The method as described in claim 10 further comprising:
receiving a selection of a set of sensors of the plurality of sensors via a graphical user interface; and
storing a portion of metadata associated with the set of sensors as the parameter associated with the event;
wherein the received data associated with the plurality of sensors is displayed via the graphical user interface by at least one of: a color coding, a shape, and a flashing icons;
wherein the indicator associated with the event is displayed via the graphical user interface by at least one of: a pop-up window, a status bar, and a flashing icon.

13: The method as described in claim 10, wherein the plurality of parameters associated with the event comprises a radiation threshold for a set location, wherein the plurality of parameters further comprise a set distance range from the set location.

14: The method as described in claim 10, wherein the plurality of parameters comprises a distance between the first sensor and a second sensor of the plurality of sensors.

15: The method as described in claim 14, wherein the plurality of parameters further comprises a time interval between a first sensor reading from the first sensor and a second sensor reading from the second sensor.

16: The method as described in claim 10, wherein the plurality of parameters comprises a distance range between a first sensor and a second sensor of the plurality of sensors.

17: The method as described in claim 10, wherein the plurality of parameters associated with the event comprise a rate of travel of an object past a first sensor and a second sensor of the plurality of sensors.

18: A system comprising:
a parameter module configured to receive a parameter for defining an event;
a data module configured to receive data associated with a plurality of sensors;
an event determination module configured to determine whether the event has occurred based on: the data associated with the plurality of sensors, and the parameter defining the event; and
a visualization module configured to output of an indicator based on occurrence of the event.

19: The system of claim 18, wherein the condition associated with the event comprises a set of readings from the plurality of sensors varying outside a specified limit.

20: The method of claim 18 further comprising:
a messaging module configured to send an indicator associated with the event.
